(19) United States
(12) Patent Application Publication
(10) Pub. No.: US 2025/0209100 A1
(43) Pub. Date: Jun. 26, 2025

(54) METHOD AND SYSTEM FOR TRAINING RETRIEVERS AND RERANKERS USING ADAPTERS

(71) Applicant: NAVER CORPORATION, Seongnam-si (KR)

(72) Inventors: Stéphane CLINCHANT, Meylan (FR); Carlos LASSANCE, Grenoble (FR); Hervé DÉJEAN, Grenoble (FR); Vaishali PAL, Grenoble (FR)

(21) Appl. No.: 18/417,335

(22) Filed: Jan. 19, 2024

Related U.S. Application Data
(60) Provisional application No. 63/614,116, filed on Dec. 22, 2023.

(51) Int. Cl. G06F 16/33; G06F 16/383

(52) U.S. Cl. CPC G06F 16/3344; G06F 16/383

(57) ABSTRACT

In a method for training a first-stage neural retriever, adapter layers are inserted into one or more transformer layers of a pretrained language model (PLM) in an encoder configured to receive one or more documents and generate a sparse representation for each of the documents. The first-stage retriever is trained on a downstream task to update one or more parameters of the inserted adapter layers.

### PRIORITY INFORMATION

This application claims priority to and benefit from U.S. Provisional Patent Application Ser. No. 63/614,116, filed Dec. 22, 2023, which application is incorporated in its entirety by reference herein.

### FIELD

The present disclosure relates generally to machine learning, and more particularly to methods and systems for training neural language models such as ranking models for information retrieval using adapters.

### BACKGROUND

It is useful to provide IR (Information Retrieval) methods in which most of the involved computation can be done offline and where online inference is fast. Learning dense embeddings to conduct retrieval using efficient approximate nearest neighbors (ANN) methods has shown good results, but such methods are still combined with BOW (Bag Of Words) models (e.g., combining both types of signals) due to their inability to explicitly model term matching.

There has been a growing interest in learning sparse representations for queries and documents. Using sparse representations, models can inherit desirable properties from BOW models such as exact match of (possibly latent) terms, efficiency of inverted indexes, and interpretability. Additionally, by modeling implicit or explicit (latent, contextualized) expansion mechanisms, similarly to standard expansion models in IR, models can reduce vocabulary mismatch.

Dense retrieval based on Bidirectional Encoder Representations from Transformers (BERT) models is a standard approach for candidate generation in question answering and information retrieval tasks. An alternative to dense indexes is term-based ones. For instance, building on standard BOW models, Zamani et al. disclosed SNRM (in “From Neural Re-Ranking to Neural Ranking: Learning a Sparse Representation of Inverted Indexing”, and published in Proceedings of the 27th ACM International Conference on Information and Knowledge Management (Torino, Italy) (CIKM '18), Association for Computing Machinery, New York, NY, USA, pp. 497-506, 2018), in which a model embeds documents and queries in a sparse high-dimensional latent space using L1 regularization on representations.

More recently, there have been attempts to transfer knowledge from pretrained language models (PLMs) to sparse approaches. For example, based on BERT, DeepCT (Dai and Callan, 2019, Context-Aware Sentence/Passage Term Importance Estimation For First Stage Retrieval, arXiv:1910.10687 [cs.IR]) focuses on learning contextualized term weights in the full vocabulary space, akin to BOW term weights.

Information Retrieval (IR) systems often aim to return a ranked list of documents ordered with respect to their relevance to a user query. Configurations of IR systems can involve significant complexity. For example, current IR systems such as web search engines typically use several retrieval models, which are specialized in diverse information needs such as different search verticals. Further, IR systems usually are multi-stage, including a first stage retriever and a second stage reranker. Such multi-stage retrieval is configured to consider a tradeoff between effectiveness and efficiency, in which the first stage retrievers are configured for fast retrieval of potentially relevant candidate documents from a large corpus, and the rerankers focus on effectiveness.

There have been efforts to use learned (neural) rankers for first-stage retrievers to address issues such as the vocabulary mismatch problem, in which relevant documents might not contain terms that appear in the query. PLMs such as those based on BERT models are increasingly popular for natural language processing (NLP) and for re-ranking tasks in information retrieval. PLM-based neural models have shown a strong ability to adapt to various tasks by simple fine-tuning.

PLM-based ranking models can provide improved results for passage re-ranking tasks, but such models introduce challenges of efficiency and scalability. Because of practical efficiency requirements, PLM-based models conventionally were used only as re-rankers in a two-stage ranking pipeline, while a first stage retrieval (or candidate generation) is conducted with BOW models that rely on inverted indexes or term-based approaches such as BM25 for first-stage ranking.

U.S. patent application Ser. No. 17/804,983, filed May 5, 2023, published as U.S. Patent Pub. No. 2023/0214633 on Jul. 6, 2023, and U.S. patent application Ser. No. 18/312,703, filed May 5, 2023, each of which are incorporated herein by reference, disclose use of sparse information retrieval models based on PLMs, in which queries and optionally documents are encoded in a sparse high-dimensional latent space for a first-stage retriever and optionally a second stage reranker. Neural ranker models (rankers) are provided for document ranking in information retrieval (IR) by generating (vector) representations that are sparse enough to allow the use of inverted indexes for retrieval. This is faster and more reliable than methods such as approximate nearest neighbor (ANN) methods, and enables exact matching, while performing comparably to neural IR representations using dense embedding.

Example rankers can combine rich term embeddings such as can be provided by PLMs such as Bidirectional Encoder Representations from Transformers (BERT)-based LMs, where documents are represented by tokens in a particular vocabulary space. Such models can provide sparsity that allows efficient matching algorithms for IR based on inverted indexes.

With the advent of large pretrained language models (PLM), recent neural retrieval models have millions of parameters. Training and updating PLM-based models to learning downstream tasks via finetuning involves significant computing and storage cost, and thus more efficient methods are desired. Additionally, generalizability across out-of-domain datasets is critical, but even when effectively adapted to new domains, full finetuning often comes at the expense of large storage and/or catastrophic forgetting.

### SUMMARY

Provided herein are methods and systems for training a first-stage neural retriever. Adapter layers are inserted into one or more transformer layers of a pretrained language model (PLM) in an encoder of the first-stage retriever. The encoder is configured to receive one or more documents and generate a sparse representation for each of the documents predicting term importance of the document over a vocabulary. The first-stage retriever is trained on a downstream task, wherein the training updates one or more parameters of the inserted adapter layers. The updated one or more parameters of the inserted adapter layers are stored. First-stage retrievers trained using example methods are also provided.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example processor-based system for information retrieval (IR) of documents.

FIG. 2 shows an example processor-based method for encoding an input sequence to provide a sparse representation.

FIG. 3 shows an example neural encoder for performing the method of FIG. 2.

FIG. 4 shows an example process for comparing documents and queries using an efficiency-enhanced neural ranking model.

FIG. 5 shows an example training approach for a neural ranking model including regularization.

FIG. 6 shows features of an example transformer layer and an inserted adapter.

FIG. 7 illustrates an example method for training an information retrieval model using adapters.

FIG. 8A shows an example method for adaptive tuning of a first-stage retriever.

FIG. 8B shows an example method for transforming a first-stage retriever (ranker) into a reranker using adapters.

FIG. 9 shows an example architecture in which example methods can be implemented.

In the drawings, reference numbers may be reused to identify similar and/or identical elements.

### DETAILED DESCRIPTION

### Introduction

Retrieval models based on PLM require finetuning millions of parameters, which makes them memory inefficient and less scalable for adaptation, such as but not limited to out-of-domain adaptation. This provides a need for efficient training methods to adapt them to information retrieval tasks.

Parameter-efficient tuning has been employed in some methods for natural language processing (NLP) models to address concerns such as large storage and catastrophic forgetting. However, conventional systems and methods have not sufficiently incorporated parameter-efficient techniques such as adapters for more efficient training of retrievers for IR.

Systems and methods provided herein provide, among other things, incorporation of adapters into neural IR systems including retrievers. The adapters allow for useful configuration or optimization of a tradeoff between efficiency (computational speed; e.g., the number of queries the ranker (or retriever) model is able to process in a given time, or equivalently the amount of time taken by the model to process a query (latency)) and effectiveness (quality of lexical expansions and/or quality of IR results).

For example, adapter-based tuning of IR models can be performed with a lower training cost, such as fewer parameters or lower hardware requirements (e.g., smaller GPUs) as compared to conventional full finetuning of IR models while providing comparable results. Similarly, for the same training cost as conventional IR models using full finetuning, example adapter-training can be configured to improve effectiveness, such as but not limited to using larger models to train. In some examples, adapter-based training can surprisingly provide both improved efficiency and effectiveness.

Experiments examining use of adapters for sparse retrieval models demonstrate that with approximately 2% of training parameters, adapters can be successfully employed for sparse retrieval models with comparable or even better effectiveness than for full finetuning on benchmark IR datasets (e.g., MS MARCO, TREC DL 2019 and 2020) and on out-of-domain BEIR datasets. Removing adapter layers can provide a further reduction in training parameters while retaining effectiveness of full finetuning. For domain adaptation, adapters were demonstrated to be more stable and to outperform finetuning (which is prone to overfitting).

Additional example systems and methods can further generalize neural sparse retrievers with adapter-based tuning on datasets such as but not limited to BEIR and on out-of-domain datasets such as but not limited to TripClick. Still other example systems and methods can provide knowledge transfer between first stage retrievers and second stage rerankers with adapter-tuning as compared to full fine-tuning.

### Parameter Efficient Transfer Learning

Parameter efficient transfer learning techniques are transfer learning techniques that aim to adapt large pretrained models to downstream tasks using a fraction (e.g., less than 100%, less than 50%, less than 20%, less than 10%, less than 5%, less than 2%, less than 1%, etc.) of training parameters, while achieving at least comparable effectiveness to full fine-tuning. Example methods can be memory efficient and can scale well to numerous downstream tasks due to the significant reduction in task-specific training parameters. Such techniques can thus be useful for more efficient storage and deployment compared to fully fine-tuned instances.

Parameter-efficient transfer learning techniques have been applied to NLP tasks such as language translation, natural language generation, tabular question answering, and to benchmarks such as the GLUE benchmarks. However, parameter-efficient methods have heretofore not been implemented in IR using sparse retrieval.

One category of parameter efficient transfer learning is so-called addition-based methods, which insert intermediate modules such as adapter modules into a pretrained model having transformer layers. The newly added modules are adapted to a downstream task while the remainder of the pretrained model is kept frozen. The adapter modules can be added vertically by increasing the model depth.

A nonlimiting example adapter module is Houlsby Adapters, e.g., as disclosed in Houlsby et al., Parameter-efficient transfer learning for nip, Chaudhuri, K., Salakhutdinov, R. (eds.) ICML, Proceedings of Machine Learning Research, vol. 97, pp. 2790-2799. PMLR (2019). Other example adapter modules include Pfeiffer Adapters, e.g., as disclosed in Pfeiffer et al., Mad-x: An adapter-based framework for multi-task cross-lingual transfer. In: EMNLP (2020). Houlsby Adapters can be employed, for instance, by inserting small bottle-neck layers after both the multi-head attention and feedforward layer of each transformer layer. The Houlsby Adapters may be optimized for natural language processing (NLP) tasks, e.g., on a benchmark such as the GLUE benchmark (e.g., see Han et al., Robust transfer learning with pretrained language models through adapters (2021), https://doi.org/10.48550/ARXIV.2108.02340, https://arxiv.org/abs/2108.02340; Rückle et al., AdapterDrop: On the efficiency of adapters in transformers, In Proceedings of the 2021 Conference on Empirical Methods in Natural Language Processing, pp. 7930-7946. Association for Computational Linguistics, Online and Punta Cana, Dominican Republic (November 2021)). Pfeiffer Adapters can be employed by inserting a bottle-neck layer after only the feedforward layer. Houlsby Adapters and Pfeiffer Adapters have previously demonstrated comparable effectiveness to fine-tuning on various NLP tasks.

Other example adapters use prompt-based adapter methods such as Prefix-tuning (Li et al. Prefix-tuning: Optimizing continuous prompts for generation, In Proceedings of the 59th Annual Meeting of the Association for Computational Linguistics and the 11th International Joint Conference on Natural Language Processing (Volume 1: Long Papers). pp. 4582-4597, Association for Computational Linguistics, Online (August 2021)), which prepend continuous task-specific vectors to an input sequence, where the task-specific vectors are optimized as free-parameters. Another example adapter method, Compacter (e.g., see Mahabadi et al., Parameter-efficient multi-task fine-tuning for transformers via shared hypernetworks, In ACL (2021) optimizes a model by learning transformations of the bottle-neck layer in a low-rank subspace, leading to less parameters.

Addition-based methods using adapters can be distinguished from other categories of parameter efficient transfer learning such as so-called specification-based methods, in which only a subset of pretrained model parameters are fine-tuned to the task at hand, while the remainder of the model remains frozen. Such fine-tuned model parameters can be, for example, only the bias terms (e.g., BitFit (Zaken et al., BitFit: Simple parameter-efficient finetuning for transformer-based masked language-models, in Proceedings of the 60th Annual Meeting of the Association for Computational Linguistics (Volume 2: Short Papers), pp. 1-9. Association for Computational Linguistics, Dublin, Ireland (May 2022)), or only cross-attention weights (e.g., Seq2Seq models with X-Attention (e.g., Gheini et al., Cross-attention is all you need: Adapting pretrained Transformers for machine translation. In: Proceedings of the 2021 Conference on Empirical Methods in Natural Language Processing. pp. 1754-1765)). Another category of parameter efficient transfer learning is so-called re-parametrization methods, in which the pretrained weights are transformed into parameter efficient form during training. An example reparameterization method is LoRA (Hu et al., Lora: Low-rank adaptation of large language models (2021)), which optimizes rank decomposition matrices of a pretrained layer while the original layer is kept frozen.

Parameter efficient transfer learning for IR generally has shown promising results for dense retrieval models. For example, Jung et al., Semi-siamese bi-encoder neural ranking model using lightweight fine-tuning, In Proceedings of the ACM Web Conference 2022, p. 502-511. WWW '22, Association for Computing Machinery, New York, NY, USA (2022), discloses using parameter efficient prefix-tuning. Lassance and Clinchant, An efficiency study for splade models, In Proceedings of the 45th International ACM SIGIR Conference on Research and Development in Information Retrieval. pp. 2220-2226 (2022); and Hu et al., 2021, discloses using parameter efficient tuning on bi-encoder and cross-encoder dense models. Additionally, it has been disclosed to combine these two methods by sequentially optimizing one method for m epochs, freezing it, and optimizing the other n epochs. However, while cross-encoders with LoRA and LoRA+(50% more parameters compared to LoRA) can outperform fine-tuning such as with TwinBERT and CoIBERT, parameter-efficient methods do not outperform fine-tuning for bi-encoders across all datasets.

In contrast to dense bi-encoder models, example methods and systems herein can use adapters for sparse retrieval models for improved parameter-efficient training. Nonlimiting examples are described herein using a sparse information retrieval framework, exemplary embodiments of which referred to as SPLADE.

Example models may use distinct adapters for query and document encoders in a so-called bi-adapter setting in which the same pretrained backbone model is used by both the query and the document encoders but different adapters are trained for the queries and the documents. Additional example models may provide efficient domain adaptation (that is, adaptation as further finetuning on a target domain) for neural first-stage rankers. In such examples, a trained neural ranker may be provided and adapted with adapters on a different domain, a nonlimiting example of which is provided by the domains present in the BEIR benchmark. Still other example models share parameters between rerankers and first stage rankers using adapters.

### Sparse Information Retrieval Models

Example rankers include one or more encoders that encode an input sequence, such as a document or query, to provide sparse representations (sparse vector representations or sparse lexical expansions; i.e., where a subset of parameters may represent a larger set of parameters; e.g., where a subset of parameters are the only non-zero parameters that form part of a larger set of parameters of a model represented using a high-dimensional vector space; a sparse matrix is a matrix in which most elements are zero) in the context of IR by predicting a term importance of the input sequence over a vocabulary. Such systems and methods can provide, among other things, expansion-aware representations of documents and queries.

An example encoder includes a pretrained language model (PLM), trained, e.g., using a self-supervised pretraining objective, to determine a prediction of an importance (or weight) for the input sequence over the vocabulary (term importance) with respect to tokens of the input sequence. A representation providing the predicted importance of the input sequence over the vocabulary can be obtained by performing an activation that includes a concave function to prevent some terms from dominating.

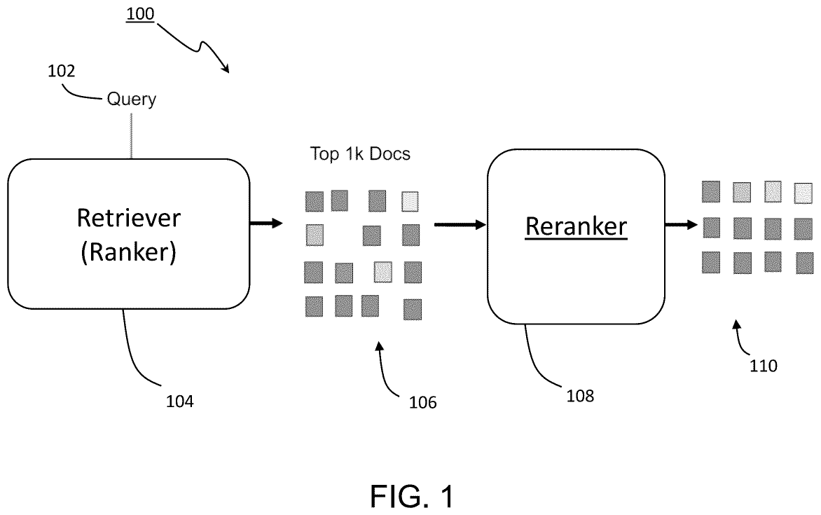

Referring now to the drawings, FIG. 1 shows an example system 100 using a neural model for information retrieval (IR) of documents, such as but not limited to a search engine, which may be configured and trained using adaptive training methods as provided herein. A query 102 is input to a first-stage retriever (ranker) 104. Example queries include but are not limited to search requests or search terms for providing one or more documents (of any format), questions to be answered, items to be identified, etc. The first-stage retriever or ranker 104 processes the query 102 to provide a ranking of available documents, and retrieves a first set 106 of top-ranked documents. A second-stage or reranker 108 then reranks the retrieved set 106 of top-ranked documents and outputs a ranked set 110 of documents, which may be fewer in number than the first set 106.

Example neural ranker models according to embodiments herein may be used for providing rankings for the first-stage retriever or ranker 104, as shown in FIG. 1, in combination with a second-stage reranker 108. Example second-stage rerankers 108 include but are not limited to rerankers implementing learning-to-rank methods such as LambdaMart, RankNET, or GBDT on handcrafted features, or rerankers implementing neural network models with word embedding (e.g., word2vec). Neural network-based rerankers can be representation based, such as DSSM, or interaction based, such as DRMM, K-NRM, or DUET. In other example embodiments, example neural ranker models herein can alternatively or additionally provide rankings for the second stage reranker 108. In other embodiments, example neural ranker models can be used as a standalone ranking and possibly retrieval stage.

Example neural ranker models, whether used in the first-stage 104, the second stage 108, or as a standalone model, may provide representations, e.g., vector representations, of an input sequence over a vocabulary. The input sequence can be embodied in, for instance, a query sequence such as the query 102, a document sequence to be ranked and/or retrieved based on a query, or any other input sequence. “Document” as used herein broadly refers to any sequence of tokens that can be represented in vector space and ranked using example methods and/or can be retrieved. A query broadly refers to any sequence of tokens that can be represented in vector space for use in ranking and retrieving one or more documents.

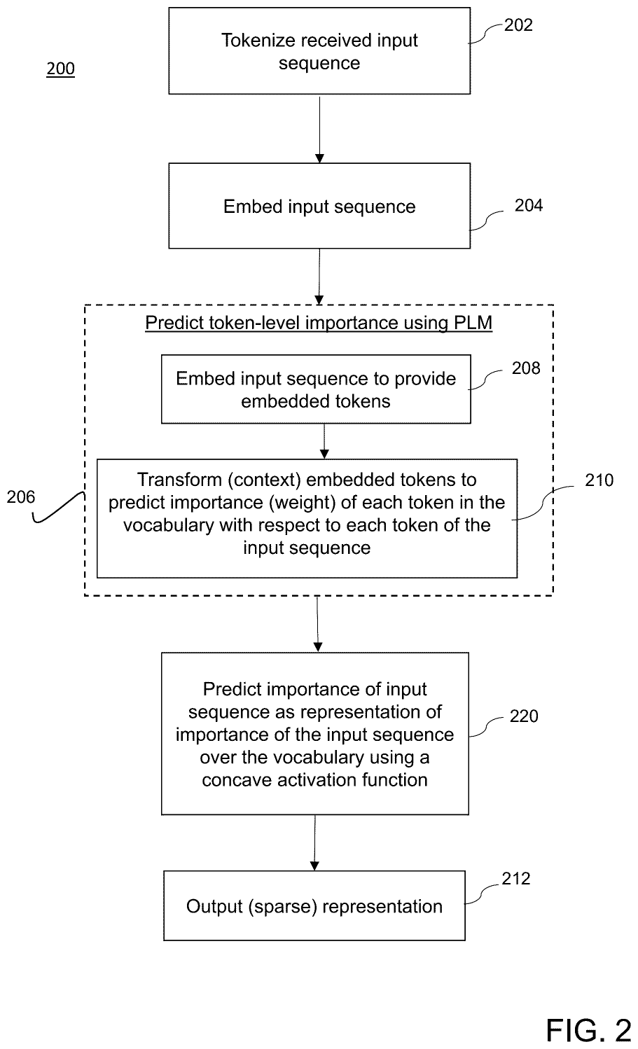

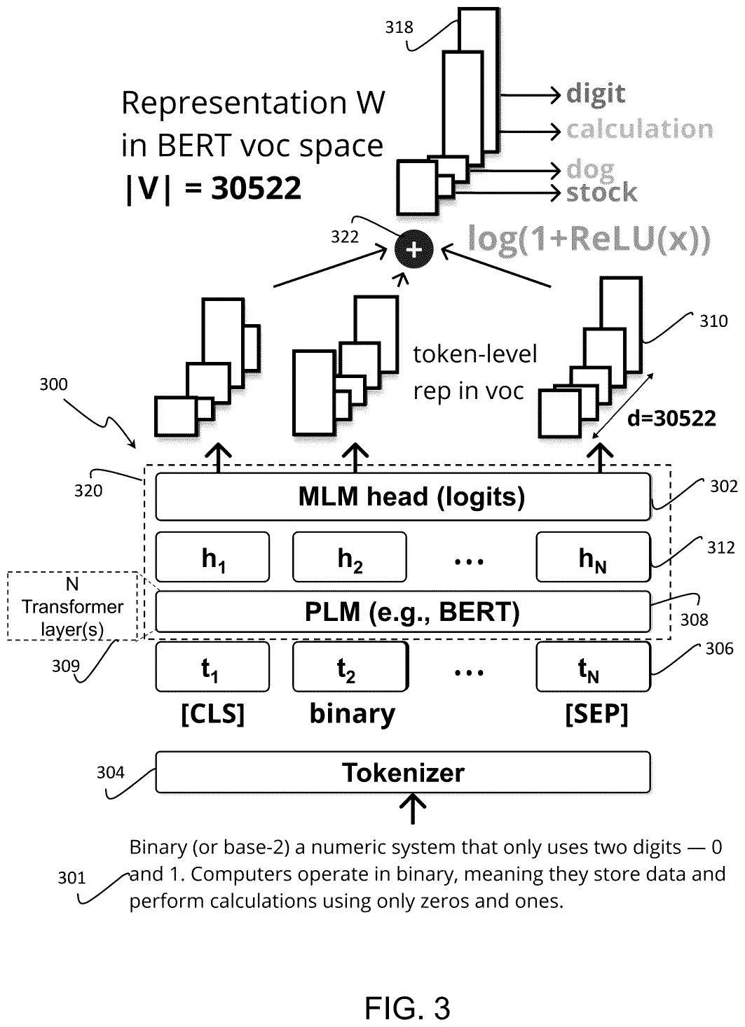

FIG. 2 shows an example encoding method 200 employing a pretrained language model (PLM), and FIG. 3 shows an example encoder 300 of a neural ranker model, such as ranker 104, for performing the encoding method 200. An example PLM can be based on a transformer architecture, such as but not limited to architectures disclosed in U.S. Pat. No. 10,452,978, issued Oct. 22, 2019, which is incorporated by reference herein. The transformer architecture may be composed of N stacked transformer layers, an example of which is shown as 309.

The example encoding method 200 encodes an input sequence by providing a representation of the input sequence over a vocabulary. The vocabulary may be predetermined. A nonlimiting example vocabulary that may be used is BERT WordPiece vocabulary (└V┘=30522), which representation may be used for ranking and/or reranking in IR.

The encoder 300 can be implemented by one or more computers having at least one processor and one memory. For instance, the encoder 300 may be implemented using one or more CPU cores, alone or in combination with one or more GPUs, along with a suitable memory.

Neural sparse first stage retrievers can learn contextualized representations of documents and queries in a sparse high-dimensional latent space. The example encoder 300 can infer sparse representations for input sequences, e.g., queries or documents, directly by providing query and/or document expansion. Example encoders 300 can perform expansion using a PLM having transformer layers 309. PLMs include but are not limited to PLMs trained using methods such as Masked Language Model (MLM) training methods. For instance, the encoder 300 can perform expansion based on the log its (i.e., unnormalized outputs) 302 of a Masked Language Model (MLM)-trained PLM 320. Regularization may be used to train example retrievers to ensure or encourage sparsity, as described in more detail herein.

An example PLM having transformer layers may be based on BERT. BERT, e.g., as disclosed in Devlin et al, 2019, BERT: Pre-training of Deep Bidirectional Transformers for Language Understanding, CoRR abs/1810.04805, incorporated herein by reference, is a family of transformer-based training methods and associated models, which may be pre-trained on two tasks: masked-token prediction, referred to as a “masked language model” (MLM) task”; and next-sentence prediction. These example models are bidirectional in that each token attends to both its left and right neighbors, not only to its predecessors. Example encoders 300 can exploit PLMs such as those provided by BERT-based models to project token-level importance over a vocabulary (such as over a BERT vocabulary space, or other vocabulary space) for an input sequence, and then obtain predicted importance of the input sequence over the vocabulary to provide a representation of the input sequence.

The input sequence 301 received by the encoder 300 is tokenized at 202 by a tokenizer layer 304 using the vocabulary (for example, a predetermined BERT vocabulary) to provide a tokenized input sequence t₁ . . . t_{N} 306. The tokenized input sequence 306 may also include one or more special tokens, such as but not limited to <CLS> (a symbol added in front of an input sequence, which may be used in some BERT methods for classification) and/or <SEP> (used in some BERT methods for a separator), as can be used in BERT embeddings.

Token-level importance or local importance is predicted at 206 using the pretrained LM 320. Token-level or local importance refers to an importance (or weight, or representation) of each token in the vocabulary with respect to each token of the input sequence.

Each token of the tokenized input sequence 306 may be embedded at 208 to provide a sequence of embedded tokens h₁ . . . h_{N} 312. This embedding may be a context embedding based on, for instance, the vocabulary and the token's position within the input sequence. The embedded (e.g., context embedded) tokens h₁ . . . h_{N} 312 may represent contextual features of the tokens within the embedded input sequence. An example embedding 208 may use one or more embedding layers of the PLM 320, e.g., one or more transformer-based layers such as BERT layers 308, including one or more transformer layers 309 as described in further detail herein.

Token-level or local importance of the input sequence can be predicted over the vocabulary (e.g., BERT vocabulary space, as shown) at 210 from the embedded tokens 312. A head (log its) 302 of the PLM 320 may be used to predict an importance (or weight) of each token of the vocabulary with respect to each token of the input sequence of tokens; that is, a (input sequence) token-level or local representation 310 in the vocabulary space. For instance, for a PLM trained using MLM methods, the head 302 may be an MLM head that transforms the context embedded tokens 312 using one or more linear layers, each including at least one log it function, to predict an importance (e.g., weight, or other representation) of each token in the vocabulary with respect to each token of the embedded input sequence and provide the token-level representation 310 in the vocabulary space.

For example, consider an input query or document sequence after tokenization 202 (e.g., WordPiece tokenization) t=(t₁, t₂, . . . t_{N}), and its corresponding BERT embeddings (or BERT-like model embeddings) after context embedding 208 (h₁, h₂, . . . h_{N}). The importance wᵢⱼ of the token j (vocabulary) for a token i (of the input sequence) can be provided at step 210 by:

$${w}_{ij} = {transform ( {h}_{i} )}^{T} {E}_{j} + {b}_{j} j ∈ \{ 1 , … ⌊ V ⌋ \} \qquad ( 1 )$$

where Eⱼ denotes the BERT (or BERT-like model) embedding resulting from the tokenizer and the model parameter for token j (e.g., a vector representing token j without taking into account the context), bⱼ is a token-level bias, and transform(·) is a linear layer with Gaussian error linear unit (GeLU) activation, e.g., as disclosed in Hendrycks and Gimpel, arXiv:1606.08415, 2016, and a normalization layer LayerNorm. GeLU can be provided, for instance, by x [symbol] xΦ(x), or can be approximated in terms of the tanh(·) function (as the variance of the Gaussian goes to zero one arrives at a rectified linear unit (ReLU), but for unit variance one gets GeLU). T can correspond, for example, to a transpose operation in linear algebra, e.g., to indicate that in the end it is a dot product and may be included in the transform function. Since Equation (1) can be equivalent to the MLM prediction, it can also be initialized, for instance, from a pretrained MLM model (or other PLM).

The encoder 300 then predicts at 220 term importance of the input sequence 318 (e.g., a global term importance for the input sequence) as a representation of importance (e.g., weight) of the input sequence over the vocabulary by performing an activation using a representation layer 322. The representation layer 322 performs a concave activation function over the embedded input sequence. The predicted term importance of the input sequence predicted at 220 may be independent of the length of the input sequence. The concave activation function can be, as nonlimiting examples, a logarithmic activation function or a radical function (e.g., a sqrt (1+x) function; a mapping w→({square root over (1+ReLU(w)))}−1)^{k} for an appropriate scaling k, etc.).

For instance, a final representation of importance 318 of the input sequence 301 over the vocabulary can be obtained by the encoder 300 by combining (or maximizing, for example) importance predictors over the input sequence tokens, and applying a concave function such as a logarithmic function after applying an activation function such as ReLU to ensure the positivity of term weights:

$${w}_{j} = {max}_{i ∈ t} log ( 1 + ReLU ( {w}_{ij} ) ) \qquad ( 2 )$$

The above example model provides a log-saturation effect that prevents some terms from dominating and (naturally) ensures sparsity in representations. Logarithmic activation has been used, for instance, in computer vision, e.g., as disclosed in Yang Liu et al., Natural-Logarithm-Rectified Activation Function in Convolutional Neural Networks, arXiv, 2019, 1908.03682. While using a log-saturation or other concave functions prevents some terms from dominating, the implied sparsity obtains improved results and allows obtaining of sparse solutions without regularization.

The final representation 318 (i.e., the predicted term importance of the input sequence) from the encoder 300, may be output at 212. This representation may be compared to representations from other sequences, including queries or documents, or, since the representations are in the vocabulary space, simply to tokenizations of sequences (e.g., a tokenization of a query over the vocabulary can provide a representation).

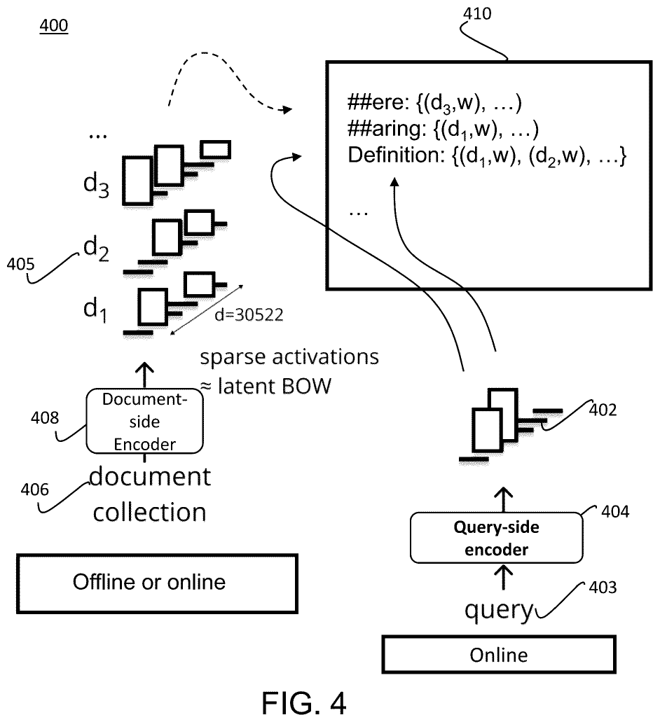

FIG. 4 shows an example comparison method 400 that may be used for document scoring in IR. A representation 402 of a query 403 generated by a query-side encoder or query encoder 404 is compared using a comparator block 410 to representations 405 of each of a plurality of candidate sequences, e.g., generated offline, online, or a combination of offline and online, for a document collection 406 by a document-side encoder or document encoder 408. The candidate sequences 405 may be respectively associated with candidate documents (or themselves are candidate documents) for information retrieval.

In some embodiments, the document-side encoder 408 and the query-side encoder 404 may be embodied in the same encoder, such as the encoder 300 (shown in FIG. 3). An example of this is referred to as a mono-encoder setup herein. In other embodiments, the document-side encoder 408 and the query-side encoder 404 can be separate encoders. The query-side encoder 404 may be embodied, for instance, in a differently-configured PLM-based encoder or in a model other than a PLM-based encoder, such as but not limited to a tokenizer, for providing a representation of the query. In still other embodiments, the document-side encoder 408 and the query-side encoder 404 can be based on a shared (frozen) PLM but with separately trained adapters to provide separate encoders, an example of which is referred to as a bi-adapter setup herein.

An example comparison (performed by the comparator block 410) between the representations 405, 402 generated by the document-side encoder 408 and the query-side encoder 404 may include, for instance, taking a dot product between the representations. This comparison may provide a ranking score. The plurality of candidate sequences associated with the representations 405 can then be ranked, e.g., based on the determined ranking score, and a subset of the documents 406 (e.g., the highest ranked set, a sampled set based on the ranking, etc.) can be retrieved. Although example methods are described herein with reference to a first-stage ranker, this retrieval can be performed during the first (ranking) and/or the second stage (reranking) of an IR method.

### Training the First-Stage Ranker in a Neural IR Model

An example training method for the first-stage ranker 104 of the neural ranker model 100 will now be described. The first-stage ranker 104 may include a document-side encoder 408 (shown in FIG. 4), an embodiment of which may be provided by an encoder configured as in encoder 300 (shown in FIG. 3). The neural ranker model 104 may further include a query-side encoder 404, an embodiment of which may be provided by the document-side encoder 408, by a separate encoder configured according to encoder 300 but configured differently than the document-side encoder, by a separate PLM-based encoder other than encoder 300, by an encoder not based on a PLM, by a tokenizer, etc.

Training herein may refer to training the document-side encoder 408 and/or the query-side encoder 404. Training may include but is not limited to training or tuning for downstream tasks such as information retrieval, domain adaptation, generalization, transfer learning between document-side and query-side encoders or vice versa, or others.

Training the neural ranker model 104 may begin by initializing parameters of the model(s) including the document-side and query-side encoders, e.g., weights and biases. The parameters may be iteratively adjusted after evaluating an output result produced by the model 104 for a given input against the expected output.

Some parameters may be pretrained, such as but not limited to parameters of a PLM. Initial parameters may additionally or alternatively be randomized or initialized (for example) in any suitable manner. For adapter-based tuning (or adaptive tuning), adapters incorporated into transformer layers 309 of the encoder 300 providing the document-side encoder 408 or the query-side encoder 404 may be trained (adapter parameters may be updated) while other parameters, such as one or more, or all, parameters of the PLM, may be frozen as described in further detail below. However, it is also possible that some parameters of the PLM may also be updated during the fine-tuning process. All adapter layers, or a subset of adapter layers, may be updated during adapter-based tuning.

Neural ranking models may be trained, for instance, using in-batch negative (IBN) sampling, in which some negative documents are included from other queries to provide a ranking loss that can be combined with sparsity regularization in an overall loss. Training using in-batch negative sampling can improve the performance of example models. Neural ranking models may also be trained using distillation to provide more accurate evaluations of query-document pairs.

For example, the neural ranker model 104 may be trained using a dataset including a plurality of documents. The dataset may be used in batches to train the neural ranker model 104, including parameters of one or more adapter layers. The dataset may include a plurality of documents including a plurality of queries. For each of the queries the dataset may further include at least one positive document (a document associated with the query) and at least one negative document (a document not associated with the query). Negative documents can include hard negative documents, which are not associated with any of the queries in the dataset (or in the respective batch), and/or negative documents that are not associated with the particular query but are associated with other queries in the dataset (or batch). Hard documents may be generated, for instance, by sampling a model such as but not limited to a ranking model.

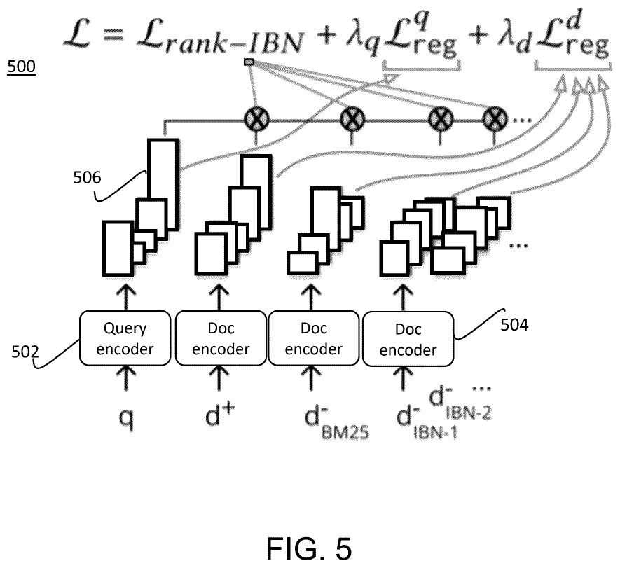

FIG. 5 shows an example training approach for a neural ranking model 500 employing an in-batch negatives (IBN) sampling strategy. The neural ranking model 500 includes a query encoder 502 and a document encoder (doc encoder) 504. The document and query encoders 502, 504 may both be embodied in an encoder such as the encoder 300 (shown in FIG. 3), or may be embodied in separate encoders such as the encoder 300 or other encoders.

Let s(q, d) denote the ranking score obtained from a dot product between q and d representations, e.g., representations generated from Equation (2) or representations provided by other encoders (for instance, if the query and documents encoders are separate). Given a query qᵢ in a batch, a positive (relative) document dᵢ⁺, a (hard) negative (not-relevant) document dᵢ⁻ (e.g., coming from sampling a ranking function, e.g., from BM25 sampling), and a set of negative (not-relevant) documents in the batch (in-batch negatives) provided (optionally) by positive (relevant) documents from other queries {d_{i,j}⁻}, the ranking loss or contrastive loss can be interpreted as the maximization of the probability of the document dᵢ⁺ being relevant among the documents dᵢ⁺, dᵢ⁻, and {d_{i,j}⁻}:

$${ℒ}_{rank - IBN} = - log \frac{{e}^{s ( {q}_{i} {d}_{i}^{+} )}}{{e}^{s ( {q}_{i} , {d}_{i}^{+} )} + {e}^{s ( {q}_{i} , {d}_{i}^{-} )} + {\sum }_{j} {e}^{s ( {q}_{i} , {d}_{i , j}^{-} )}} \qquad ( 3 )$$

The example neural ranker model 500 can be trained by minimizing the contrastive loss in Equation (3).

The ranking loss may be supplemented to provide for regularization. One example regularization that may be used is sparsity regularization. However, other regularizations may be used as disclosed in more detail herein.

Paria et al., “Minimizing FLOPs to Learn Efficient Sparse Representations”, arXiv:2004.05665, 2020, discloses a FLOPS regularizer, which provides a smooth relaxation of the average number of floating-point operations (FLOPS) necessary to compute the score of a document, and hence directly related to the retrieval time. The FLOPS regularizer can be defined using aⱼ as a continuous relaxation of the activation (i.e., the term has a non-zero weight) probability pⱼ for token j, and estimated for documents d in a batch of size N by

$${\overline{a}}_{j} = \frac{1}{N} {\sum }_{i = 1}^{N} {w}_{j}^{( {d}_{i} )} .$$

This can provide the following regularization loss:

$${ℓ}_{FLOPS} = {\sum }_{j ∈ V} {\overline{a}}_{j}^{2} = {\sum }_{j ∈ V} ( \frac{1}{N} {\sum }_{i = 1}^{N} {w}_{j}^{( {d}_{i} )} )$$

Example neural ranker models may combine one or more of the above features to provide training, such as but not limited to end-to-end training, of sparse, expansion-aware representations of documents and queries. For instance, example models can learn the log-saturation model provided by Equation (2) by jointly optimizing ranking and regularization losses:

$$ℒ = {ℒ}_{rank - IBN} + {λ}_{q} {ℒ}_{reg}^{q} + {λ}_{d} {ℒ}_{reg}^{d} \qquad ( 4 )$$

In Equation (4), [symbol] _{reg} is a sparse regularization e.g., [symbol] ₁ or [symbol] _{FLOPS}). Two distinct regularization weights (λ_{q} and λ_{d}) for queries and documents, respectively, can be provided in the example loss function, allowing additional pressure to be put on the sparsity for queries, which is highly useful for fast retrieval.

Neural ranker models may also employ pooling methods to further enhance effectiveness and/or efficiency. For instance, by straightforwardly modifying the pooling mechanism disclosed above, example models may increase effectiveness by a significant margin.

An example max pooling method may provide the sum in Equation (2) above by a max pooling operation:

$${w}_{j} = {max}_{i ∈ t} log ( 1 + ReLU ( {w}_{ij} ) ) \qquad ( 5 )$$

In some example methods, to further improve retrieval efficiency, a middle training step may be performed on pretrained LM-based encoders between pretraining and fine-tuning. Alternatively, a middle training step may be performed concurrently with pretraining and before fine-tuning. The middle training improves a state of the ranker for fine-tuning. An example middle training step may include training the pretrained LM using a masked language model (MLM) loss (such as but not limited to the MLM loss used for pretraining) combined with a FLOPS regularization step. In other embodiments, the middle training step can be combined with a pretraining step for the LM.

It is not necessary for the document and query encoders to be embodied in the same encoder, but instead separate encoders may be used. For example, the document encoder 408 may be embodied in an encoder such as the encoder 300 including the PLM model 320 for document expansion, whereas the query encoder 404 can be configured to encode the query, with or without query expansion. If the query encoder 404 does not employ query expansion, this can provide a document expansion-only neural ranking model and method.

Document expansion-only models can be inherently more efficient, as documents can then be pre-computed and indexed offline, while providing results that remain competitive. Such methods can be provided in combination with other features provided herein.

In document expansion only methods, there are no query expansions nor term weighting, and thus a ranking score s(q, d) can be provided simply by comparing a tokenization of the query in the vocabulary (e.g., provided by the query encoder 404) to (e.g., pre-computed) representations of documents that can be generated by the document encoder 408 using a pretrained LM-based model:

$$s ( q , d ) = {\sum }_{j ∈ q} {w}_{j}^{d} \qquad ( 6 )$$

Example training methods may incorporate distillation. Distillation can be provided in combination with features of any of the example models or training methods. An example distillation-based training method may be based on methods disclosed in Hofstatter et al., Improving Efficient Neural Ranking Models with Cross-Architecture Knowledge Distillation, arXiv:2010.02666, 2020. Distillation techniques can be used to further boost example model performance, as demonstrated by experiments.

Example distillation training can include at least two steps. In a first step, both a first stage retriever, e.g., as disclosed herein, and a reranker, such as those disclosed herein (one nonlimiting example is HuggingFace, as provided by huggingface.co/cross-encoder/ms-marco-MiniLM-L-12-v2) are trained using triplets (e.g., a query q, a relevant passage p⁺, and a non-relevant passage p⁻), e.g., as disclosed in Hofstatter et al., 2020, Improving Efficient Neural Ranking Models with Cross-Architecture Knowledge Distillation, arXiv:2010.02666. In a second step, triplets are generated with harder negatives using an example model trained with distillation, and the reranker is used to generate the desired scores. A ranker model may then be trained from scratch using these triplets and scores. The result of this second step provides a distilled ranker model. Features of example distillation methods are described in more detail below.

To generate features that are efficient for nearest-neighbor retrieval, SPLADE may use a regularization such as a FLOPS regularization (e.g., as disclosed in B. Paria et al.), to control the amount of expected operations, e.g., as described above. Example sparse retrieval models such as SPLADE can further be optimized via distillation, as described above.

Such models can jointly optimize, for instance, the distance between teacher and student scores, and can minimize the expected mean FLOPS of the retrieval system. This joint optimization can be described as:

$$ℒ = {ℒ}_{distillation} + {λ}_{q} {ℒ}_{FLOPS}^{q} + {λ}_{d} {ℒ}_{FLOPS}^{d}$$

Where [symbol] _{FLOPS} is the sparse FLOPS regularization and [symbol] _{distillation} is a distillation loss between the scores of a teacher and a student (e.g., using KL Divergence as the loss, and a cross-ranker disclosed in Rodrigo Nogueira and Kyunghyun Cho. 2019. Passage Re-ranking with BERT, arXiv:1901.04085 [cs.IR] as teacher). As there are two distinct regularization weights, one can put more sparsity pressure on either queries or documents, but always considering the amount of FLOPS.

Parameter-Efficient Information Retrieval Training with Adapters

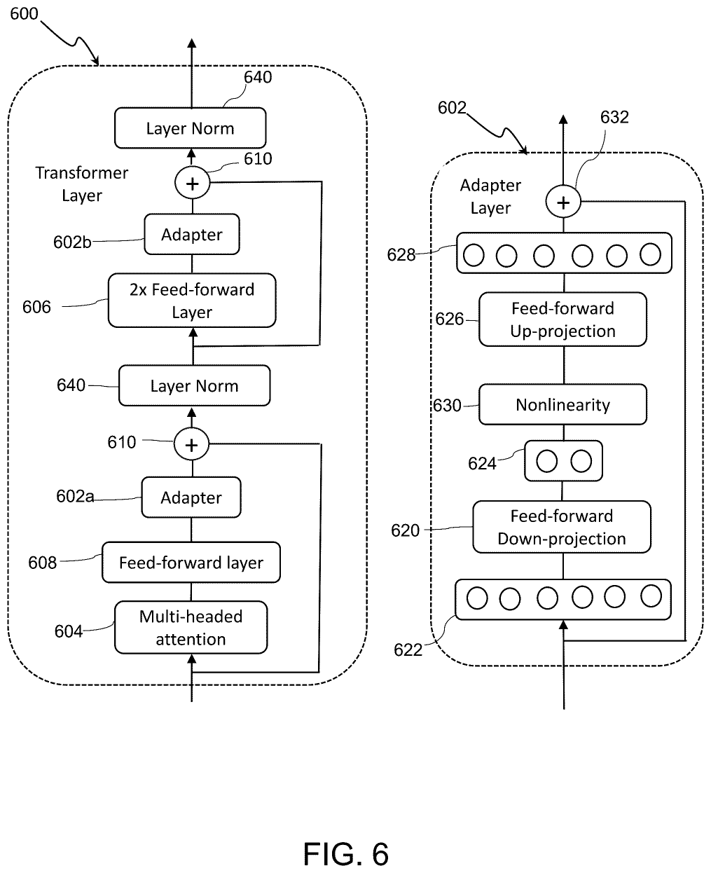

As disclosed above, PLMs 320 such as provided in the encoder 300 may be based on or otherwise include a transformer architecture composed of N stacked transformer layers, such as transformer layers 309 or other transformer layers. FIG. 6 shows an example transformer layer 600, e.g., which may be provided in a PLM. One or more of the N transformer layers 600 includes adapter layers (adapters) 602 inserted therein according to an example embodiment, e.g., as illustrated by adapters 602a, 602b.

Each of the N transformer layers 600 has a first sublayer including a multi-headed attention (self-attention) layer or module 604 and a second sublayer including a fully connected feed-forward layer or module 606. An additional feed-forward layer 608 is provided in the first sublayer downstream of the multi-headed attention layer 606.

Each attention layer, e.g., multi-headed attention module 604, has a function of a query matrix (Q E R^{nXd}k), a key matrix, and a value matrix. The attention can be formally written as:

$$A ( Q , K , V ) = softmax ( \frac{{QK}^{T}}{\sqrt{{d}_{k}}} ) V \qquad ( 7 )$$

Where the query Q, key K, and value V are parameterized by weight matrices W_{q}∈R^{nXd}^{ₖ}, Wₖ∈R^{nXd}^{ₖ}, and Wᵥ∈R^{nXd}^{ᵥ}, as Q=XW_{q}, K=XWₖ, and V=XWᵥ. Each of the N heads has its respective Qᵢ, Vᵢ, and Kᵢ weights and its corresponding attention Aᵢ. The feed-forward layer takes as input a transformation of the concatenation of the N attentions as:

$$FFN ( x ) = σ ( {XW}_{1} + {b}_{1} ) {W}_{2} + {b}_{2} \qquad ( 8 )$$

Where σ(·) is the activation function. A residual connection 610 is further added after each attention layer 604 and feed-forward layer 606.

The adapters 602 are inserted in each transformer sublayer, e.g., downstream of the fully connected feed-forward layer 606 and downstream of the feed-forward layer 608 following the attention module 604, and upstream of the residual connection 610 in each sublayer, such as shown by adapters 602a, 602b. The example adapter 602 shown in FIG. 6 is a Houlsby adapter, as disclosed by example in Houlsby et al., Parameter-efficient transfer learning for nip, In Chaudhuri, K., Salakhutdinov, R. (eds.) ICML. Proceedings of Machine Learning Research, vol. 97, pp. 2790-2799, PMLR (2019). In other embodiments, a Pfeiffer adapter or other adapter may be used. The Houlsby adapter is an additive adapter, in that it inserts trainable parameters in addition to existing layers such as the transformer layers 600. In the transformer layer 600, a layer normalization 640 may be added after each transformer sublayer, e.g., downstream of the residual connection 610.

The added modules provided by the adapter layer 602 form a bottle-neck architecture including a down-projection layer (feedforward down-projection layer) 620 that receives an input 622 in a d-dimensional space and down-projects the input to a bottle-neck representation 624 in a bottle-neck dimension d, an up-projection layer (feedforward up-projection layer) 626 that up-projects the bottle-neck representation back to the d-dimensional space 628, and a non-linear transformation (nonlinearity) 630. The size of the bottle-neck controls the number of training parameters in the adapter layer 602. A residual connection 632 is applied across each adapter layer 602.

This can be formally defined as:

$$x = f ( {hW}_{down} ) {W}_{up} + x \qquad ( 9 )$$

Where x∈R^{d} is the input 622 to the adapter layer 602, W_{down}∈R^{dXr} is the down projection matrix 620 transforming input x into bottle-neck dimension d 624, and Wᵤₚ∈R^{rXd} is the up-projection matrix 626 transforming the bottle-neck representation back to the d-dimensional space. Each adapter can be initialized with near-identity weights, for instance, to provide more stable training.

### Adaptive Training of Neural Sparse First Stage Retrievers

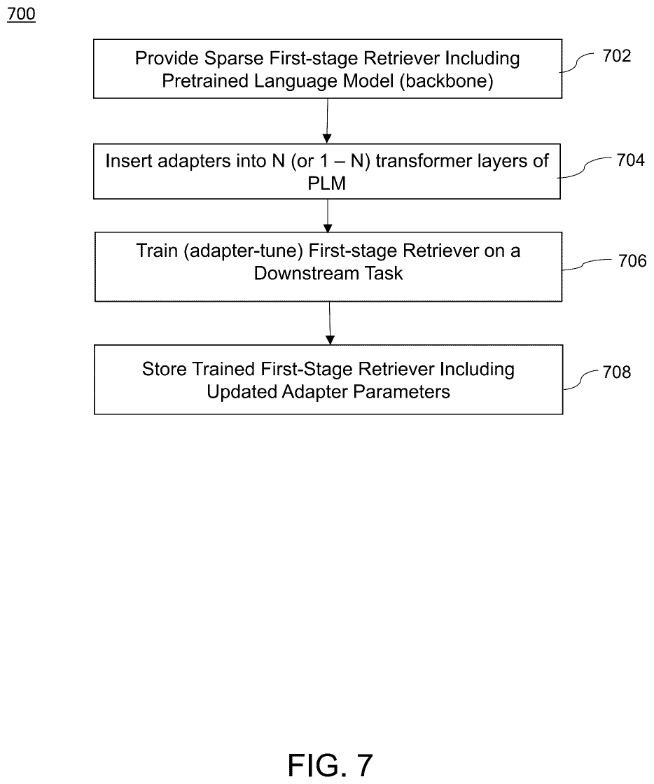

FIG. 7 shows an example method 700 for adaptive training of a (neural) sparse first-stage retriever. In the example method, 700, a sparse first-stage retriever including a PLM having a transformer architecture composed of N stacked transformer layers is provided at 702. The sparse first-stage retriever may provide or include a pretrained backbone model.

An example sparse first-stage retriever for adaptive training can be configured as in the sparse retrievers disclosed herein as well as those provided in Formal et al., From distillation to hard negative sampling: Making sparse neural IR models more effective, In Proceedings of the 45th International ACM SIGIR Conference on Research and Development in Information Retrieval. p. 2353-2359. SIGIR '22, Association for Computing Machinery, New York, NY, USA (2022); in Lassance et al, An efficiency study for splade models, In Proceedings of the 45th International ACM SIGIR Conference on Research and Development in Information Retrieval. pp. 2220-2226 (2022); and in U.S. Pat. Pub. 2023/0214633.

One or more adapter layers are inserted into one or more (e.g., 1 to N) transformer layers of the sparse retriever at 704, if such adapter layers are not already present. For instance, the adapter layers may be inserted into the transformer layers 600 as shown in FIG. 6, or in other ways. If Houlsby adapters are used, such as the adapters 602 shown in FIG. 6, the adapters may be inserted after both the multi-head attention 604 and feed-forward layer 606 of each transformer layer that is adapted. If Pfeiffer adapters are used, the adapters may be inserted, for instance, after only the feed-forward layer of each transformer layer that is adapted. Each adapter layer 602 preferably has trainable parameters and includes bottle-neck layers such as down-projection and up-projection layers 620, 626. For example, the adapter layers 602 may include a first set of (e.g., trainable) parameters, and the PLM may include a second set of (e.g., trainable) parameters. The second set of parameters, for instance, may be larger than the first set of parameters. In one embodiment, the first set of parameters is 80% to 100% smaller than the second set of parameters. The encoder or retriever may include additional parameters other than those of the PLM.

The sparse first-stage retriever, including the PLM having inserted adapter layers, is trained on a downstream task at 706 including updating parameters of one or more of the inserted adapter layers 602. In a mono-encoder setting, the query and document may share a single encoder and adapters are trained for the single encoder. Alternatively, in a bi-encoder setting, the same pretrained backbone model may be used by both the query and the document encoder but distinct adapters may be trained for the queries and documents.

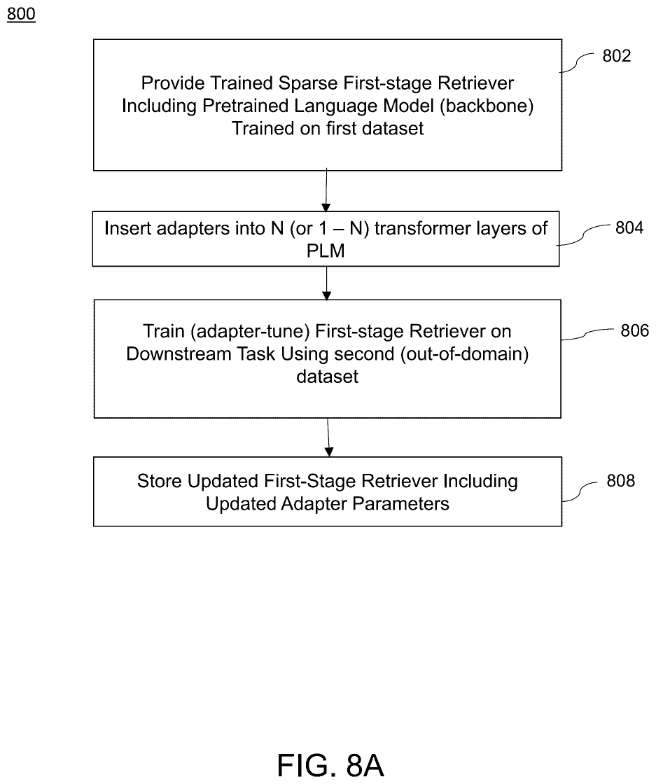

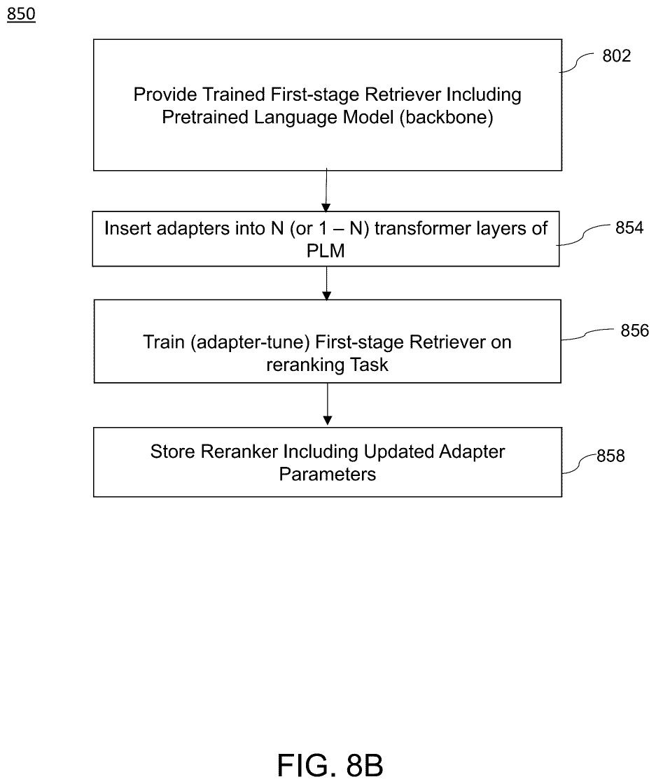

The sparse retriever with the inserted adapters may be trained (trained, fine-tuned, adapter-tuned, etc.) at 706 on tasks such as but not limited to information retrieval tasks, domain adaptation tasks (described in more detail below with reference to FIG. 8), generalization tasks, transfer learning, or other tasks, including but not limited to downstream tasks.

In training the adapters 602, all or a subset of the trainable parameters in the adapters (e.g., parameters in one, all, or a subset of the adapter layers in transformer layers) may be trained (updated). Other parameters of the first-stage retriever, such as but not limited to transformer parameters of the pretrained PLM, may be kept frozen or be updated, in any combination, though keeping such parameters frozen during training can improve efficiency and/or performance. Adapters may be provided using addition-based methods, where an example adaptive tuning (adapting) method freezes the pretrained language model (PLM) while training the adapter layers. Example training of sparse first-stage retrievers may use regularizations such as L₁ and FLOPS regularization to force sparsity.

The updated first-stage retriever, including updated parameters of at least one inserted adapter and updated parameters of the remaining PLM (if any) are stored at 708. The stored updated first set of parameters of the inserted adapter layers may represent a (e.g., larger) second set of parameters in the PLM. In one embodiment, the first set of parameters is 80% to 100% smaller than the second set of parameters. The adapter-tuned retrieval model may then be used for information retrieval during runtime (inference).

For illustrating the adaptive training method 700, an example adapter-tuned sparse first stage retriever 104 which may be provided at step 702 will now be described, referred to as a SPLADE sparse retriever (or simply SPLADE). The example SPLADE sparse retriever includes an encoder (which may be configured similarly to encoder 300) that predicts term weights of each vocabulary token j (e.g., over vocabulary └V┘) with respect to an input token i as:

$${w}_{ij} = {transform ( {h}_{i} )}^{T} {E}_{j} + {b}_{j} j ∈ \{ 1 , … ⌊ V ⌋ \} \qquad ( 10 )$$

Where Eⱼ is the j^{th} vocabulary token embedding, bⱼ is its bias, hᵢ is i^{th} input token embedding, and transform(·) is a linear transformation followed by an activation (e.g., GeLU) and a normalization layer LayerNorm. The final term importance for each vocabulary term j can be obtained by taking the maximum predicted weights over the entire input sequence of length n, after applying a log saturation effect:

$${w}_{j} = {max}_{n} log ( 1 + ReLU ( {w}_{ij} ) ) \qquad ( 11 )$$

Given a query qᵢ, the ranking score s of a document d can be defined by the degree to which it is relevant to q obtained as a dot product s(q, d)=w(q)·w(d).

In an example training method 700, a learning objective is to discriminate representations obtained from Equation (11) of a relevant document d⁺ and non-relevant hard-negatives d⁻, e.g., obtained by BM25 and in-batch negatives d_{i,j}⁻ by minimizing the contrastive loss:

$$L = - log \frac{{e}^{s ( {q}_{i} , {d}_{i}^{+} )}}{{e}^{s ( {q}_{i} , {d}_{i}^{+} )} + {e}^{s ( {q}_{i} , {d}_{i}^{-} )} + \sum j {e}^{s ( {q}_{i} , {d}_{i , j}^{+} )}} \qquad ( 12 )$$

An example learning objective with distillation minimizes a MarginMSE loss (e.g., as disclosed in Formal et al., 2022)), which is the mean-squared error between the positive negative margins of a cross-encoder teacher and the student:

$$L = MSE ( {M}_{s} ( {q}_{i} , {d}^{+} ) - {M}_{s} ( {q}_{i} , {d}^{-} ) , {M}_{t} ( {q}_{i} , {d}^{+} ) - {M}_{t} ( {q}_{i} , {d}^{-} ) ) \qquad ( 13 )$$

Where MSE is the mean-squared error, Mₜ is the teacher's margin, and Mₛ is the student's margin. The final objective optimizes either of the objectives in Equations (12) or (13) with regularization losses:

$${ℒ}_{SPLADE} = L + {λ}_{q} {ℒ}_{1} + {λ}_{d} {ℒ}_{FLOPS} \qquad ( 14 )$$

$$Where {ℒ}_{FLOPS} = {\sum }_{j ∈ V} {\overline{a}}_{j}^{2} = {\sum }_{j ∈ V} ( \frac{1}{N} {\sum }_{i = 1}^{N} {w}_{j}^{( {d}_{i} )} ) \qquad ( 15 )$$

The FLOPS regularizer is a smooth relaxation of the average number of floating-point operations (FLOPS) necessary to compute the score of a document, and thus is directly related to the retrieval time. It can be defined using a continuous relaxation of the activation (that is, the term has a non-zero weight) probability for token j, and estimated or documents d in a batch of size n by āⱼ².

Example sparse retrieval methods may also be assessed based on retrieval flops (referred to as R-FLOPS), which are the number of floating point operations on an inverted index to return the list of documents for a given query. The R-FLOPS metric can be defined by an estimation of the average number of floating-point operations between a query and a document, which is defined as the expectation

$${𝔼}_{q , d} [ {\sum }_{j ∈ V} {p}_{j}^{( q )} {p}_{j}^{( d )} ] ,$$

where pⱼ is the activation probability for token j in a document d or a query q. It can be empirically estimated, for instance, from a set of development queries (e.g., 100 k, though this can be greater or fewer) on a dataset such as the MS MARCO collection. The R-FLOPS metric is thus an indication of the inverted index sparsity and of the computation cost for a sparse model (which is different from the inference or forward cost of the model).

### Cross-Encoding Rerankers

Another way to use PLMs for neural retrieval is to use so-called cross-encoding, such as disclosed in Yates et al., Pretrained transformers for text ranking: Bert and beyond, In Proceedings of the 14th ACM International Conference on Web Search and Data Mining. pp. 1154-1156 (2021). For cross-encoding, both query and document are concatenated before being provided to the neural network, and the score is directly computed by the neural network. A cross-encoding procedure allows for networks that are much more effective, but at the cost of efficiency as the retrieval procedure now has to go through the entire network for each query document pair, instead of being able to precompute document representations and only go through the network for the query representation. The models can be trained with a contrastive loss such as provided in Equation (12) that aims to maximize the score of the true query/document pair compared to a (e.g., BM25) negative query/document pair, without using in-batch negatives.

FIG. 8A shows an example adapting method 800 for adapting a trained model on an out-of-domain dataset. In the example adapting method 800, a trained sparse first-stage retriever including a PLM having a transformer architecture composed of N stacked transformer layers is provided at 802. The trained sparse first-stage retriever is trained, e.g., for an information retrieval task or other task on a first dataset, such as an in-domain dataset. For instance, the trained sparse first-stage retriever may be pre-finetuned. One or more adapter layers are inserted into one or more transformer layers of the trained sparse retriever, e.g., layers of the PLM, at 804. The trained sparse first-stage retriever, including the PLM having inserted adapter layers, is trained on a downstream task including by training one or more of the inserted adapter layers at 806. The training at 806 may be for an information retrieval task, e.g., such as provided herein, using an out-of-domain dataset. The out-of-domain dataset may be a smaller dataset, a larger dataset, or a dataset of equal size. If an addition-based method is used, the PLM model may be frozen and the adapter layers updated. The updated retrieval model including parameters of updated adapter layers, is stored at 808. Adapters may also be used to address unsupervised domain adaptation.

FIG. 8B shows an example method 850 for transforming a first-stage retriever (ranker) into a reranker using adapters, thus sharing knowledge between first stage rankers and rerankers. In the example method 850, a trained first-stage retriever (dense or sparse) including a PLM having a transformer architecture composed of N stacked transformer layers is provided at 852. One or more adapter layers are inserted into one or more transformer layers of the trained retriever, e.g., layers of the PLM, at 854. The trained first-stage retriever, including the PLM having inserted adapter layers, is trained including by training one or more of the inserted adapter layers at 856. The training at 856 is for a reranking task. If an addition-based method is used, the PLM model may be frozen and the adapter layers updated. The new reranker model including parameters of updated adapter layers is stored at 858.

### Experiments

In experiments for illustrating inventive features, sparse retrieval models were trained using adaptive-tuning methods according to example embodiments. Example sparse first-stage retrieval models, referred to generally as SPLADE models, were configured as disclosed in Lassance et al., An efficiency study for splade models, In Proceedings of the 45th International ACM SIGIR Conference on Research and Development in Information Retrieval. pp. 2220-2226 (2022). Sparse first-stage retrieval models for processing queries and documents were adapted to provide variants of adapted models, which in experiments are referred to generally as Adapter-SLADE models.

Example SPLADE models were implemented using an L₁ regularization for the query, and using FLOPS regularization for the document as disclosed in Lassance et al., 2022. In most variants of the adapted sparse retrieval models (with exceptions provided below) the document regularization weight λ_{d} was set to 9e-5 and the query regularization weight λ_{q} was set to 5e-4 for training.

To mitigate the contribution of the regularizer at the early stages of training, a scheduler was used for λ as disclosed in Paria et al., Minimizing flops to learn efficient sparse representations, In International Conference on Learning Representations (2019). The scheduler quadratically increased λ at each training iteration until the 50 k step. Experiments used a learning rate of 8e-5, a batch size of 128, a linear scheduler, and warmup step of 6000. The maximum sequence length was set to 256.

The example models were trained for 300 k iterations, and the best checkpoint using MRR@10 on the validation set was used. A bottle-neck reduction factor of 16 (that is, 16 times smaller) was used for all example adapter layers. Pytorch (Paszke et al., Pytorch: An imperative style, high performance deep learning library, In Advances in neural information processing systems 32 (2019)), Huggingface Transformers (Wolf et al., Transformers: State-of-the-art natural language processing, In Proceedings of the 2020 conference on empirical methods in natural language processing: system demonstrations. pp. 38-45 (2020)), and AdapterHub (Beck et al., Adapterhub playground: Simple and flexible few-shot learning with adapters, In ACL (2022)) were used to train all models on 4 Tesla V100 GPUs with 32 GB memory. Statistical significance was computed with p≤0.05 using the Student's t-test. Superscripts were used to identify statistical significance for nearly all measures except for metrics related to BEIR.

Encoding with Adapters

Experiments used two settings of encoding with adapters. One setting, referred to in the Tables below as “adapter,” is a mono-encoder setup where the query and the document share a single encoder. For the adapter setting, the adapter layers were optimized with both the query and the document input sequences while keeping the pretrained language model (PLM) frozen.

The other setting, referred to in the Tables below as “bi-adapter,” is a bi-encoder setup that separates query and document encoders, including inserting and training distinct query and document adapters on a shared frozen PLM. This example setting provides benefits from optimizing exclusive adapters for input sequence type, such as but not limited to the ability to (optionally) use different lengths of query and document. Additionally, it is possible to (optionally) use smaller PLMs for the queries instead of sharing PLM weights.

Two different backbone PLMs were used in experiments: DistiIBERT; and CC+MLM Flops, a pretrained PLM of a cocondenser trained on the masked language model (MLM) task using FLOPS regularization, such as disclosed in Lassance et al., 2022, to make it easier to work with the example SPLADE models. Adapter-SPLADE was trained and evaluated on the MS MARCO passage ranking dataset (Nguyen et al., Ms marco: A human generated machine reading comprehension dataset, In CoCo@NIPs (2016)) in full ranking setting. Table 1, below, shows results for fine-tuning and adapter-tuning with BM25 triplets.

TABLE 1

| | | | MS MARCO dev | | TREC DL 2019 | TREC DL 2020 | | Training |
|---|---|---|---|---|---|---|---|---|
| Model | # | Method | MRR@10 | R@1000 | NDCG@10 | NDCG@10 | R-Flops | Params |
| DistilBERT | a | finetuning | 0.346 | 0.963 | 0.692 | 0.677 | 1.43 | 100% |
| | b | adapter | 0.351 | 0.968^{a} | 0.711 | 0.676 | 1.44 | 2.23% |
| | c | bi-adapter | 0.352 | 0.967^{a} | 0.690 | 0.666 | 0.74 | 2.23% |
| CC + | d | finetuning | 0.366^{abc} | 0.977^{abc} | 0.712 | 0.684 | 1.09 | 100% |
| MLM FLOPS | e | adapter | 0.376^{abcd} | 0.980^{abcdf} | 0.712 | 0.688 | 0.8 | 2.23% |
| | f | bi-adapter | 0.372^{abc} | 0.976^{abc} | 0.701 | 0.700 | 0.37 | 2.23% |

Table 2 shows results for training models with distillation. In the experiments, distillation was performed using hard-negatives and scores generated by a cross-encoder reranker (Huggingface) and a MarginMSE loss (Formal et al., From distillation to hard negative sampling: Making sparse neural IR models more effective, In Proceedings of the 45th International ACM SIGIR Conference on Research and Development in Information Retrieval. p. 2353-2359, SIGIR '22, Association for Computing Machinery, New York, NY, USA (2022)). λ_{d} was set to 1 e-2 and λ_{q} was set to 9e-2.

TABLE 2

| | | | MS MARCO dev | | TREC DL 2019 | TREC DL 2020 | | Training |
|---|---|---|---|---|---|---|---|---|
| Model | # | Method | MRR@10 | R@1000 | NDCG@10 | NDCG@10 | R-Flops | Params |
| DistilBERT | a | finetuning | 0.371 | 0.979^{b} | 0.727 | 0.711 | 3.93 | 100% |
| | b | adapter | 0.373 | 0.975 | 0.728 | 0.716 | 1.86 | 2.16% |
| CC + | c | finetuning | 0.388^{ab} | 0.982^{ab} | 0.734 | 0.732 | 4.38 | 100% |
| MLM FLOPS | d | adapter | 0.390^{ab} | 0.983^{ab} | 0.740 | 0.729 | 2.34 | 2.16% |

To evaluate example adapter-tuned models for efficiency-effectiveness tradeoff, experiments compared effectiveness, R-FLOPS size, and number of training parameters of Adapters-SPLADE models with baseline finetuned counterparts having the same backbone PLM. R-FLOPS reduction provides a measure of retrieval speed, measuring the average number of floating-point operations needed to compute a document score during retrieval. A sparse embedding and subsequently lower FLOP achieves a retrieval speedup on the order of 1/p² over an inverted index, where p is the probability of each document embedding dimension being non-zero.

As shown in Tables 1-2, all example variants of adapter-tuned SPLADE outperformed each of the baseline fine-tuned counterparts on MS MARCO and TREC DL 2019. The distilled cocondenser with MLM mono-encoder model (CC+MLM FLOPS) was the highest performing, with an MRR@10 score of 0.390 and R@100 of 0.983. The difference in effectiveness between the mono-encoder and bi-encoder adaptive tuning was marginal and depended on the PLM.

The R-FLOPS were lower for the adapter-tuned models, indicating sparser representation, than for the fine-tuned counterparts. This was more pronounced in the adapter-tuned models with distillation. Additionally, the bi-adapter models had even lower R-FLOPS than the mono-encoder settings, indicating that for the same effectiveness the bi-adapters models were more efficient and sparse.

The number of training parameters was only 2.23% of the total model parameters for triplets training (1.5M/67M for mono-adapter DistilBERT, 3M/135M for bi-adapter DistilBERT, 2M/111M for CC+MLM FLOPS), and was 2.16% for the distillation process (1.5M/67M for mono-adapter DistilBERT, 2M/111M for CC+MLM FLOPS). This can be particularly useful, for instance, in a low-hardware setting where adapters with a lower number of training parameters and gradients can be trained on a smaller GPU (a nonlimiting example being 24 GB P40) though full finetuning is infeasible. In general, example adapter-tuned sparse retrieval models demonstrated a significant advantage over fine-tuning. Use of memory-efficient adapters may be expanded to larger sparse models as well.

Evaluations were also performed with the full BEIR benchmark (Thakur et al., Beir: A heterogeneous benchmark for zero-shot evaluation of information retrieval models, In Thirty-fifth Conference on Neural Information Processing Systems Datasets and Benchmarks Track (Round 2) (2021)), including 18 different datasets to measure generalizability of IR models with zero-shot effectiveness on out-of-domain data. Table 3, below, shows results of experiments. In the mono-adapter triplets training, adapter outperformed finetuning on mean nDCG@10, with the highest gap in arguana. With CC+MLM FLOPS as the backbone model, finetuning and adapter-tuning performed similarly. While adapter scores dropped for models trained with distillation, this can be attributed to the adapter representations being sparser compared to the fine-tuned models.

As illustrated by the R-FLOPS in Table 1, adapter-tuned DistiIBERT had less than half the number of R-FLOPS than its finetuned counterpart, while the CC+MLM FLOPS finetuned model had approximately 1.87 times the number of R-FLOPS of the adapter-tuned model. This was reflected in model representation capacity in zero-shot setting in Table 3. As described in further detail below, example adapters are well-suited for domain adaptation when trained on out-of-domain datasets keeping the backbone retriever intact and free from catastrophic forgetting.

TABLE 3

| | Triplets training | | | | Distillation training | | | |
|---|---|---|---|---|---|---|---|---|
| | DistilBERT | | CC + MLM FLOPS | | DistilBERT | | CC + MLM FLOPS | |
| Datasets | finetuning | adapter | finetuning | adapter | finetuning | adapter | finetuning | adapter |
| arguana | 0.298 | 0.364 | 0.427 | 0.388 | 0.513 | 0.443 | 0.463 | 0.433 |
| climate-fever | 0.167 | 0.172 | 0.180 | 0.187 | 0.202 | 0.197 | 0.229 | 0.202 |
| dbpedia-entity | 0.379 | 0.392 | 0.388 | 0.401 | 0.419 | 0.417 | 0.438 | 0.432 |
| fever | 0.730 | 0.734 | 0.724 | 0.722 | 0.773 | 0.757 | 0.792 | 0.773 |
| fiqa | 0.295 | 0.289 | 0.317 | 0.320 | 0.332 | 0.314 | 0.342 | 0.337 |
| hotpotqa | 0.626 | 0.647 | 0.650 | 0.603 | 0.687 | 0.670 | 0.687 | 0.629 |
| nfcorpus | 0.318 | 0.321 | 0.331 | 0.333 | 0.335 | 0.335 | 0.340 | 0.344 |
| nq | 0.481 | 0.482 | 0.506 | 0.523 | 0.522 | 0.508 | 0.539 | 0.544 |
| quora | 0.819 | 0.810 | 0.821 | 0.806 | 0.825 | 0.722 | 0.841 | 0.552 |
| scidocs | 0.143 | 0.150 | 0.151 | 0.153 | 0.154 | 0.147 | 0.152 | 0.153 |
| scifact | 0.614 | 0.611 | 0.658 | 0.669 | 0.687 | 0.658 | 0.690 | 0.673 |
| trec-covid | 0.694 | 0.684 | 0.668 | 0.689 | 0.703 | 0.728 | 0.700 | 0.713 |
| webis-touche2020 | 0.270 | 0.255 | 0.277 | 0.274 | 0.260 | 0.258 | 0.294 | 0.290 |
| mean | 0.449 | 0.455 | 0.469 | 0.467 | 0.493 | 0.473 | 0.500 | 0.467 |

Adapter Layer Ablation: Dropping adapter layers from transformer models can improve both training and inference time while retaining comparable effectiveness. Adapter layer ablation experiments were performed in which adapter layers were progressively removed from the early layers of the encoder. This resulted in n separate models for each layer ablation setting. The frozen pretrained model in the experiments was DistilBERT in a mono-encoder setting, where the same instance of the encoder is used to encode both the document and the query, corresponding to the configuration of the “adapter” method in Table 1. This resulted in a total of six configurations for the ablation experiments, corresponding to the six adapter layers after each pretrained transformer layer. The final experimental setting removed all size adapter layers (0-5) and fine-tuned only the language model head.

Table 4, below, shows effectiveness of each adapter ablation setting on MS MARCO, TREC DL 2019, and TREC DL 2020. There was a gradual performance drop for MS MARCO and TREC DL datasets as the training parameters decreased with the progressive removal of adapter layers. The drop was significantly higher (0.25 MRR score) when layers were removed from the second half of the model (≥0-3), which is believed to be due to task-specific information being stored in the later layers of the adapters. For the BEIR datasets, the effectiveness drop was not as evident until all adapters but the language model head were removed (configurations 0-5). The last configuration also had less sparsity, as observed from the R-FLOPS size of 2.78 compared to the other configurations. The training time also dropped proportional to the drop in adapter layers. The training time for adapter-tuning without any drop in adapter layers was 34.42 hours on 4 Tesla V100 GPUs for 150,000 iterations, and dropped to 26.70 hours with only 1% drop in MRR with the first 0-2 adapter layers dropped. The lowest training time was 21.35 hours with a drop of 3.2% in MRR for the configuration with all adapters dropped but the language model head.

TABLE 4

| | Adapters | MS MARCO dev | | TREC DL 2019 | TREC DL 2020 | BEIR | | Training | Training |
|---|---|---|---|---|---|---|---|---|---|
| # | Removed | MRR@10 | R@1000 | NDCG@10 | NDCG@10 | NDCG@10 | R-Flops | Params | Time(Hrs) |
| a | None | 0.351^{cdefg} | 0.968^{defg} | 0.711^{fg} | 0.676^{g} | 0.455 | 1.44 | 2.23% | 34.42 |
| b | 0 | 0.348^{defg} | 0.967^{efg} | 0.708^{fg} | 0.674^{g} | 0.458 | 1.27 | 2.01% | 32.23 |
| c | 0-1 | 0.344^{efg} | 0.968^{efg} | 0.709^{fg} | 0.699^{abdefg} | 0.459 | 1.34 | 1.80% | 28.55 |
| d | 0-2 | 0.341^{efg} | 0.966^{efg} | 0.703^{fg} | 0.665^{g} | 0.459 | 1.36 | 1.59% | 26.70 |
| e | 0-3 | 0.325^{fg} | 0.962^{fg} | 0.689 | 0.660^{g} | 0.455 | 1.50 | 1.37% | 24.18 |
| f | 0-4 | 0.318^{g} | 0.956 | 0.659 | 0.663^{g} | 0.455 | 1.27 | 1.15% | 22.51 |
| g | 0-5 | 0.312 | 0.955 | 0.660 | 0.617 | 0.449 | 2.78 | 0.90% | 21.35 |

Out-of-domain Dataset Adaptation: Further experiments evaluated how adapter-tuning compared to full fine-tuning when adapting a model trained on MS MARCO on a smaller out-of-domain dataset. Evaluations were conducted under two example scenarios: BEIR and TripClick.

BEIR: Three datasets (FEVER, FiQA, and NFCorpus) were used on the BEIR benchmark that have training, development, and test sets and aim for very different domains and tasks (fact checking, financial QA, and bio-medical IR). A pre-finetuned SPLADE model referred to as “splade-cocodenser-ensembledistil” disclosed in Formal et al., 2022, was provided for example networks. The experiments verified the effectiveness of the models in zero shot, and a first set of hard negatives was procured. These hard negatives were then used to train either via finetuning of all parameters or via the introduction of adapters.

The networks were trained for either 10 (FEVER) or 100 (FiQA, NFCorpus) epochs, and at the end of each epoch the development set effectiveness was computed. The models with the best development set were used to compute the first round test set effectiveness and generate hard negatives that were used for a second round of training, which repeated the first round, starting from the best network of the first round and using negatives from the first round.

Results are shown in Table 5, below. Fine-tuning was not always able to improve the results over the zero-shot, mostly due to overfitting on the training/development sets. For example, on FEVER, fine-tuning first makes all representations as it can easily overfit to the training even without using many words, and only on the second round of training started using more dimensions. By contrast, example adapter-tuning methods were able to consistently improve effectiveness over the zero-shot and first rounds. Adapter-tuning was more stable than fine-tuning when fine-tuning on these particular domains.

TABLE 5

| | | Zero Shot | | 1st Round | | 2nd Round | |
|---|---|---|---|---|---|---|---|
| Dataset | Training | NDCG@10 | Recall@100 | NDCG@10 | Recall@100 | NDCG@10 | Recall@100 |
| Fever | finetuning | 0.793 | 0.954 | 0.692 | 0.866 | 0.851 | 0.959 |
| | adapter | | | 0.841 | 0.960 | 0.881 | 0.964 |
| FiQA | finetuning | 0.348 | 0.632 | 0.371 | 0.678 | 0.356 | 0.694 |
| | adapter | | | 0.373 | 0.675 | 0.393 | 0.711 |
| NFCorpus | finetuning | 0.348 | 0.285 | 0.384 | 0.466 | 0.403 | 0.484 |
| | adapter | | | 0.362 | 0.435 | 0.371 | 0.428 |

TripClick: Further experiments were conducted on a larger bio-medical dataset, TripClick, as disclosed in Rekabsaz et al., Tripclick: The log files of a large health web search engine, In Proceedings of the 44th International ACM SIGIR Conference on Research and Development in Information Retrieval, pp. 2507-2513 (2021), https://doi.org/10.1145/3404835.3463242. The TripClick collection contains approximately 1.5 million MEDLINE documents (title and abstract), and 692,000 queries. The test set was divided into three categories of queries: Head, Torso, and Tail (according to their decreasing frequency), which contained 1,175 queries each. For the Head queries, a document-based click-through rate (DCTR) click model was employed to create relevance signals, and otherwise raw clicks were used. Triplets, as disclosed in HofstAtter et al., Establishing strong baselines for tripclick health retrieval (2022), were used.

As with the BEIR experiments, the TripClick experiments started with the “splade-cocodenser-ensembledistil” model and either fine-tuned or adapter-tuned it over 100,000 iterations, with a batch size equal to 100. Table 6, below, shows results, illustrating that adapter-tuning provided very competitive results, on par with finetuning for head categories (frequent queries) and achieving even better results for less frequent queries (torso, tail).

TABLE 6

| | | HEAD (dctr) | | HEAD | | Torso | | Tail | |
|---|---|---|---|---|---|---|---|---|---|
| # | Training | NDCG@10 | Recall@100 | NDCG@10 | Recall@100 | NDCG@10 | Recall@100 | NDCG@10 | Recall@100 |
| a | Finetuning | 0.218 | 0.579 | 0.302 | 0.523 | 0.219 | 0.679 | 0.238 | 0.722 |
| b | Adapter | 0.219 | 0.578 | 0.299 | 0.526 | 0.229^{a} | 0.679 | 0.253^{a} | 0.720 |

### Network Architecture

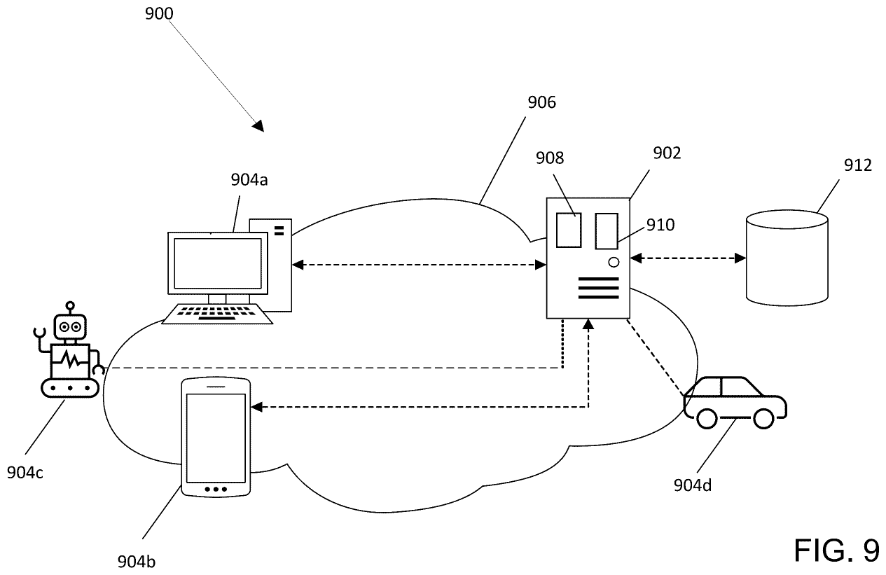

Example systems, methods, and embodiments may be implemented within a network architecture 900 such as illustrated in FIG. 9, which comprises a server 902 and one or more client devices 904 that communicate over a network 906 which may be wireless and/or wired, such as the Internet, for data exchange. The server 902 and the client devices 904a, 904b can each include a processor, e.g., processor 908 and a memory, e.g., memory 910 (shown by example in server 902), such as but not limited to random-access memory (RAM), read-only memory (ROM), hard disks, solid state disks, or other non-volatile storage media. Memory 910 may also be provided in whole or in part by external storage in communication with the processor 908. The server 902, for example, may be embodied in one or more computers. Reference herein to “computer” or “a computer” is intended to refer to one or more computers.

The IR system 100 (shown in FIG. 1) and/or the neural ranker model 104, for instance, may be embodied in the server 902 and/or client devices 904. It will be appreciated that the processor 908 can include either a single processor or multiple processors operating in series or in parallel, and that the memory 910 can include one or more memories, including combinations of memory types and/or locations. Server 902 may also include, but are not limited to, dedicated servers, cloud-based servers, or a combination (e.g., shared). Storage, e.g., a database, may be embodied in suitable storage in the server 902, client device 904, a connected remote storage 912 (shown in connection with the server 902, but can likewise be connected to client devices), or any combination.

Client devices 904 may be any processor-based device, terminal, etc., and/or may be embodied in a client application executable by a processor-based device, etc. Client devices may be disposed within the server 902 and/or external to the server (local or remote, or any combination) and in communication with the server. Example client devices 904 include, but are not limited to, autonomous computers 904a, mobile communication devices (e.g., smartphones, tablet computers, etc.) 904b, robots 904c, autonomous vehicles 904d, wearable devices, virtual reality, augmented reality, or mixed reality devices (not shown), or others. Client devices 904 may be configured for sending data to and/or receiving data from the server 902, and may include, but need not include, one or more output devices, such as but not limited to displays, printers, etc. for displaying or printing results of certain methods that are provided for display by the server. Client devices may include combinations of client devices.

In an example training method, the server 902 or client devices 904 may receive a dataset from any suitable source, e.g., from memory 910 (as nonlimiting examples, internal storage, an internal database, etc.), from external (e.g., remote) storage 912 connected locally or over the network 906. As provided above, datasets may include in-domain or out-of-domain datasets. The example training method can generate a trained model, including updated parameters of one or more adapter layers, that can be likewise stored in the server (e.g., memory 910), client devices 904, external storage 912, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

In an example document processing method the server 902 or client devices 904 may receive one or more documents from any suitable source, e.g., by local or remote input from a suitable interface, or from another of the server or client devices connected locally or over the network 906. Trained models such as the example neural ranking model 104 can be likewise stored in the server (e.g., memory 910), client devices 904, external storage 912, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

In an example retrieval method the server 902 or client devices 904 may receive a query 102 from any suitable source, e.g., by local or remote input from a suitable interface, or from another of the server or client devices connected locally or over the network 906 and process the query using example neural models (or by a more straightforward tokenization, in some example methods). Trained models such as the example neural IR model 100 and/or neural ranker model 104 can be likewise stored in the server (e.g., memory 910), client devices 904, external storage 912, or combination. Results can be output (e.g., displayed, transmitted, provided for display, printed, etc.) and/or stored for retrieving and providing on request.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

### General

Embodiments of the present invention provide, among other things, a computer-implemented method for training a first-stage neural retriever, the method may comprise inserting adapter layers into one or more transformer layers of a pretrained language model (PLM) in an encoder of the first-stage retriever, the encoder being configured to receive one or more documents and generate a sparse representation for each of the documents predicting term importance of the document over a vocabulary; training the first-stage retriever on a downstream task, wherein said training updates one or more parameters of the inserted adapter layers; and storing the updated one or more parameters of the inserted adapter layers. In addition to any of the above features in this paragraph, the encoder may comprise one of a document encoder and a query encoder. In addition to any of the above features in this paragraph, (i) the downstream task may comprise an information retrieval task; (ii) said inserting may insert adapter layers into one or more transformer layers of the PLM in an encoder of a first-stage retriever that is trained on an information retrieval task using a first, in-domain dataset, (iii) said training may use a second-out-of-domain dataset to train the first-stage retriever on an information retrieval task, and (iv) said training may update one or more parameters of the inserted adapter layers while parameters of the PLM are frozen. In addition to any of the above features in this paragraph, the first stage retriever may comprise: a document encoder comprising the pretrained language model layer including one or more transformer layers; a query encoder configured to receive a query and generate a representation of the query; and a comparator configured to compare the generated representation of the query to the generated representations of the one or more documents to generate a set of respective document scores and rank the one or more documents based on the generated set of document scores. In addition to any of the above features in this paragraph, the document encoder and the query encoder may comprise a shared encoder. In addition to any of the above features in this paragraph, the document encoder and the query encoder may be separate encoders. In addition to any of the above features in this paragraph, the document encoder and the query encoder may share the PLM but include respectively different adapter layer parameters. In addition to any of the above features in this paragraph, the training may update the parameters of the one or more of the adapter layers while one or more layers of the PLM remain frozen. In addition to any of the above features in this paragraph, the PLM may be pretrained to determine a prediction of an importance for an input sequence over the vocabulary with respect to tokens of the input sequence. In addition to any of the above features in this paragraph, the training may update a number of parameters in the adapter layers that is a fraction of trainable parameters in the PLM. In addition to any of the above features in this paragraph, the downstream task may comprise one of information retrieval, domain adaptation, generalization, reranking, and transfer learning. In addition to any of the above features in this paragraph, the PLM may be pretrained using an in-domain dataset, and said training the first-stage retriever may use an out-of-domain dataset. In addition to any of the above features in this paragraph, the transformer layers may comprise N transformer layers, each of the N transformer layers comprising: a fully-connected feedforward layer; and an attention layer having trained parameters; wherein, in between 1 and N of the transformer layers an adapter among the one or more adapters may be disposed downstream of the feedforward layer. In addition to any of the above features in this paragraph, in between 1 and N of the transformer layers another adapter among the one or more adapters may be disposed downstream of the attention layer. In addition to any of the above features in this paragraph, each of the adapter layers may comprise a bottleneck layer having trainable parameters for downprojecting an input of d-dimension into a bottleneck dimension. In addition to any of the above features in this paragraph, each of the adapter layers may comprise: a down-projection layer having trainable parameters for downprojecting an input of d-dimension into a bottleneck dimension; and an up-projection layer having trainable parameters for up-projecting the downprojected input into the d-dimension. In addition to any of the above features in this paragraph, each of the adapter layers may further comprise a nonlinearity. In addition to any of the above features in this paragraph, said training may include one or more of L1 regularization and FLOPS regularization. In addition to any of the above features in this paragraph, said training may include distillation. In addition to any of the above features in this paragraph, the ranker wherein said training may use in-batch negative sampling (IBN). In addition to any of the above features in this paragraph, the PLM may be pretrained using masked language modeling (MLM). In addition to any of the above features in this paragraph, said inserting may insert adapter layers with a first set of parameters into one or more layers of the PLM with a second set of parameters in an encoder of the first-stage retriever; wherein said training may update one or more of the first set of parameters of the inserted adapter layers; and wherein the second set of parameters may be larger than the first set of parameters and the stored updated first set of parameters of the inserted adapter layers may represent the larger second set of parameters in the pretrained language model. In addition to any of the above features in this paragraph, the one or more layers of the pretrained language model may be transformer layers. In addition to any of the above features in this paragraph, the second set of parameters of the pretrained language model may remain frozen while the first set of parameters of the adapter layers are trained. In addition to any of the above features in this paragraph, the encoder may further include a third set of parameters in addition to the second set of parameters of the pretrained language model, and the second set of parameters of the pretrained language model and the third set of parameters of the encoder may remain frozen while the first set of parameters of the adapter layers are trained.

According to additional embodiments, a first-stage retriever for a neural information retrieval model may comprise: a document encoder including a processor comprising a pretrained language model (PLM) layer including at least N transformer layers, the document encoder being configured to receive one or more documents and generate a sparse representation for each of the documents predicting term importance of the document over a vocabulary; a query encoder including a processor configured to receive a query and generate a representation of the query; and a comparator including a processor configured to compare the generated representation of the query to the generated representations of the one or more documents to generate a set of respective document scores and rank the one or more documents based on the generated set of document scores; wherein an adapter layer is inserted into each of 1 to N of the N transformer layers; and wherein the first-stage retriever is trained on an information retrieval task to update one or more parameters of the inserted adapter layers. In addition to any of the above features in this paragraph, the document encoder and the query encoder may comprise a shared encoder. In addition to any of the above features in this paragraph, the document encoder and the query encoder may share the PLM but include respectively different adapter layer parameters. In addition to any of the above features in this paragraph, the training on the information retrieval task may update a number of parameters in the adapter layers that is fewer than 10% of trainable parameters in the PLM. In addition to any of the above features in this paragraph, the PLM may be pretrained using an in-domain dataset, and said training the first-stage retriever may use an out-of-domain dataset. In addition to any of the above features in this paragraph, each of the N transformer layers may comprise: a fully-connected feedforward layer; and an attention layer having trained parameters; wherein, in between 1 and N of the transformer layers an adapter among the one or more adapters may be disposed downstream of the feedforward layer. In addition to any of the above features in this paragraph, in between 1 and N of the transformer layers another adapter among the one or more adapters may be disposed downstream of the attention layer. In addition to any of the above features in this paragraph each of the adapter layers may comprise: a down-projection layer having trainable parameters for downprojecting an input of d-dimension into a bottleneck dimension; and an up-projection layer having trainable parameters for up-projecting the downprojected input into the d-dimension. In addition to any of the above features in this paragraph, the training on the information retrieval task may include FLOPS regularization, distillation, and/or in-batch negative sampling.

According to additional embodiments, a computer-implemented method for information retrieval is provided, the method comprising: generating, by a document encoder comprising a pretrained language model (PLM) layer including one or more transformer layers having inserted adapter layers, a sparse representation for each of one or more received documents predicting term importance of the document over a vocabulary; generating, by a query encoder, a representation of a received query over the vocabulary; comparing the generated representation of the query to the generated representations of the one or more documents to generate a set of respective document scores; and ranking the one or more documents based on the generated set of document scores; wherein the document encoder is trained on a downstream task by updating parameters of the inserted adapters while the PLM remains frozen. In addition to any of the above features in this paragraph, the document encoder and the query encoder may be shared. In addition to any of the above features in this paragraph, the document encoder and the query encoder may comprise a shared PLM with separately trainable adapter layers. In addition to any of the above features in this paragraph, the document encoder may be trained on a first, in-domain dataset, and the document encoder may be further trained on the information retrieval task using a second, out-of-domain dataset.

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure. All documents cited herein are hereby incorporated by reference in their entirety, without an admission that any of these documents constitute prior art.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general-purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for training a first-stage neural retriever, the method comprising:
inserting adapter layers into one or more transformer layers of a pretrained language model (PLM) in an encoder of the first-stage retriever, the encoder being configured to receive one or more documents and generate a sparse representation for each of the documents predicting term importance of the document over a vocabulary;
training the first-stage retriever on a downstream task, wherein said training updates one or more parameters of the inserted adapter layers; and
storing the updated one or more parameters of the inserted adapter layers.

2. The method of claim 1, wherein the encoder is one of a document encoder and a query encoder.

3. The method of claim 1, wherein: (i) the downstream task is an information retrieval task; (ii) said inserting inserts adapter layers into one or more transformer layers of the PLM in an encoder of a first-stage retriever that is trained on an information retrieval task using a first, in-domain dataset, (iii) said training uses a second-out-of-domain dataset to train the first-stage retriever on an information retrieval task, and (iv) said training updates one or more parameters of the inserted adapter layers while parameters of the PLM are frozen.

4. The method of claim 1, wherein the first stage retriever comprises:
a document encoder comprising the pretrained language model layer including one or more transformer layers;
a query encoder configured to receive a query and generate a representation of the query; and
a comparator configured to compare the generated representation of the query to the generated representations of the one or more documents to generate a set of respective document scores and rank the one or more documents based on the generated set of document scores.

5. The method of claim 4, wherein the document encoder and the query encoder comprise a shared encoder.

6. The method of claim 4, wherein the document encoder and the query encoder are separate encoders.

7. The method of claim 4, wherein the document encoder and the query encoder share the PLM but include respectively different adapter layer parameters.

8. The method of claim 1, wherein the training updates the parameters of the one or more of the adapter layers while one or more layers of the PLM remain frozen.

9. The method of claim 1, wherein the PLM is pretrained to determine a prediction of an importance for an input sequence over the vocabulary with respect to tokens of the input sequence.

10. The method of claim 1, wherein the training updates a number of parameters in the adapter layers that is a fraction of trainable parameters in the PLM.

11. The method of claim 1, wherein the downstream task comprises one of information retrieval, domain adaptation, generalization, reranking, and transfer learning.

12. The method of claim 1, wherein the PLM is pretrained using an in-domain dataset, and wherein said training the first-stage retriever uses an out-of-domain dataset.

13. The method of claim 1, wherein the transformer layers comprises N transformer layers, each of the N transformer layers comprising:
a fully-connected feedforward layer; and
an attention layer having trained parameters;
wherein, in between 1 and N of the transformer layers an adapter among the one or more adapters is disposed downstream of the feedforward layer.

14. The method of claim 13, wherein in between 1 and N of the transformer layers another adapter among the one or more adapters is disposed downstream of the attention layer.

15. The method of claim 1, wherein each of the adapter layers comprises a bottleneck layer having trainable parameters for downprojecting an input of d-dimension into a bottleneck dimension.

16. The method of claim 1, wherein each of the adapter layers comprises:
a down-projection layer having trainable parameters for downprojecting an input of d-dimension into a bottleneck dimension; and
an up-projection layer having trainable parameters for up-projecting the downprojected input into the d-dimension.

17. The method of claim 16, wherein each of the adapter layers further comprises a nonlinearity.

18. The method of claim 1, wherein said training includes one or more of L1 regularization and FLOPS regularization.

19. The method of claim 1, wherein said training includes distillation.

20. The ranker of claim 1, wherein said training uses in-batch negative sampling (IBN).

21. The method of claim 1, wherein the PLM is pretrained using masked language modeling (MLM).

22. The method of claim 1, wherein said inserting inserts adapter layers with a first set of parameters into one or more layers of the PLM with a second set of parameters in an encoder of the first-stage retriever;
wherein said training updates one or more of the first set of parameters of the inserted adapter layers; and
wherein the second set of parameters is larger than the first set of parameters and the stored updated first set of parameters of the inserted adapter layers represent the larger second set of parameters in the pretrained language model.

23. The method of claim 22, wherein the one or more layers of the pretrained language model are transformer layers.

24. The method of claim 23, wherein the second set of parameters of the pretrained language model remain frozen while the first set of parameters of the adapter layers are trained.

25. The method of claim 22, wherein the encoder further includes a third set of parameters in addition to the second set of parameters of the pretrained language model, and wherein the second set of parameters of the pretrained language model and the third set of parameters of the encoder remain frozen while the first set of parameters of the adapter layers are trained.

26. A first-stage retriever for a neural information retrieval model comprising:
a document encoder including a processor comprising a pretrained language model (PLM) layer including at least N transformer layers, the document encoder being configured to receive one or more documents and generate a sparse representation for each of the documents predicting term importance of the document over a vocabulary;
a query encoder including a processor configured to receive a query and generate a representation of the query; and
a comparator including a processor configured to compare the generated representation of the query to the generated representations of the one or more documents to generate a set of respective document scores and rank the one or more documents based on the generated set of document scores;
wherein an adapter layer is inserted into each of 1 to N of the N transformer layers; and
wherein the first-stage retriever is trained on an information retrieval task to update one or more parameters of the inserted adapter layers.

27. The first-stage retriever of claim 26, wherein the document encoder and the query encoder comprise a shared encoder.

28. The first-stage retriever of claim 26, wherein the document encoder and the query encoder share the PLM but include respectively different adapter layer parameters.

29. The first stage retriever of claim 26, wherein the training on the information retrieval task updates a number of parameters in the adapter layers that is fewer than 10% of trainable parameters in the PLM.

30. The first stage retriever of claim 26, wherein the PLM is pretrained using an in-domain dataset, and wherein said training the first-stage retriever uses an out-of-domain dataset.

31. The first stage retriever of claim 26, wherein each of the N transformer layers comprises:
a fully-connected feedforward layer; and
an attention layer having trained parameters;
wherein, in between 1 and N of the transformer layers an adapter among the one or more adapters is disposed downstream of the feedforward layer.

32. The first stage retriever of claim 31, wherein in between 1 and N of the transformer layers another adapter among the one or more adapters is disposed downstream of the attention layer.

33. The first stage retriever of claim 31, wherein each of the adapter layers comprises:
a down-projection layer having trainable parameters for downprojecting an input of d-dimension into a bottleneck dimension; and
an up-projection layer having trainable parameters for up-projecting the downprojected input into the d-dimension.

34. The first stage retriever of claim 31, wherein the training on the information retrieval task includes FLOPS regularization, distillation, and/or in-batch negative sampling.

35. A computer-implemented method for information retrieval, the method comprising:
generating, by a document encoder comprising a pretrained language model (PLM) layer including one or more transformer layers having inserted adapter layers, a sparse representation for each of one or more received documents predicting term importance of the document over a vocabulary;
generating, by a query encoder, a representation of a received query over the vocabulary;
comparing the generated representation of the query to the generated representations of the one or more documents to generate a set of respective document scores; and
ranking the one or more documents based on the generated set of document scores;
wherein the document encoder is trained on a downstream task by updating parameters of the inserted adapters while the PLM remains frozen.

36. The method of claim 35, wherein the document encoder and the query encoder are shared.

37. The method of claim 35, wherein the document encoder and the query encoder comprise a shared PLM with separately trainable adapter layers.

38. The method of claim 35, wherein the document encoder is trained on a first, in-domain dataset, and wherein the document encoder is further trained on the information retrieval task using a second, out-of-domain dataset.
